(19) United States
(12) Patent Application Publication
(10) Pub. No.: US 2013/0148000 A1
(43) Pub. Date: Jun. 13, 2013

(54) SOLID-STATE IMAGING DEVICE

(71) Applicant: PANASONIC CORPORATION, Osaka (JP)

(72) Inventors: Takahiko MURATA, Osaka (JP); Takayoshi YAMADA, Hyogo (JP); Yoshihisa KATO, Shiga (JP)

(73) Assignee: PANASONIC CORPORATION, Osaka (JP)

(21) Appl. No.: 13/759,558

(22) Filed: Feb. 5, 2013

Related U.S. Application Data
(63) Continuation of application No. PCT/JP2011/000646, filed on Feb. 4, 2011.

(30) Foreign Application Priority Data
Aug. 9, 2010 (JP) 2010-178960

(51) Int. Cl. H04N 5/335

(52) U.S. Cl. CPC H04N 5/335
USPC 348/308

(57) ABSTRACT

The MOS solid-state imaging device includes: pixels arrayed two-dimensionally; first column signal lines; first holding circuit units each of which corresponds to one of the first column signal lines and holds electrical signals that are transmitted from the pixels through one of the first column signal lines; and first difference circuit units that each output a difference between one of the electrical signals in the reset state and one of the electrical signals in the light-received state that are held by one of the first holding circuit units, in which the first holding circuit units each include pixel-wise holding circuits, the number of which is identical to the number of the pixels provided for the corresponding one of the first column signal lines, the pixel-wise holding circuits being able to hold electrical signals in the reset state of the pixels and electrical signals in the light-received state of the pixels.

### CROSS REFERENCE TO RELATED APPLICATIONS

This is a continuation application of PCT International Application No. PCT/JP2011/000646 filed on Feb. 4, 2011, designating the United States of America, which is based on and claims priority of Japanese Patent Application No. 2010-178960 filed on Aug. 9, 2010. The entire disclosures of the above-identified applications, including the specifications, drawings and claims are incorporated herein by reference in their entirety.

### FIELD

The present invention relates to metal oxide semiconductor (MOS) and complementary metal oxide semiconductor (COMS) solid-state imaging devices (hereinafter referred to as a MOS solid-state imaging device) that are incorporated into, for example, a digital camera.

### BACKGROUND

In recent years, a technique as recited in Patent Literature 1 has been suggested to achieve a high-speed shutter operation using a CMOS image sensor (MOS solid-state imaging device). There has been a trend in recent years towards an increase in the number of pixels used in a MOS solid-state imaging device. An increase has been also seen in the amount of signals that are processed by a signal processing circuit in a MOS solid-state imaging device and a signal processing circuit in a digital camera and others having a MOS solid-state imaging device. Here, when high-speed signal processing is required, for example, for capturing video, pixel signals are combined to reduce the amount of signals to be processed. The following describes the example of a pixel signal combining method of a conventional MOS solid-state imaging device, with reference to FIG. 20 (see Patent Literature 1).

FIG. 20 shows a circuit that combines pixel signals generated in the MOS solid-state imaging device.

In this circuit, after a signal from a first pixel and a signal from a second pixel are stored in a capacitor 207 and a capacitor 208, respectively, a switch 209 including a MOS transistor becomes conductive so that the signals from the first and second pixels are combined and outputted to an output line 210.

Such a technique can reduce the amount of signals to be processed, as compared to when pixel signals are not combined.

### CITATION LIST

### Patent Literature

[PL1] Japanese Unexamined Patent Application Publication No 2001-292453

### SUMMARY

### Technical Problem

However, the operation mode of the MOS solid-state imaging device recited in Patent Literature 1 has a problem that video distortion is caused by different timing of reading pixel signals for each pixel group due to the function of a focal-plane shutter.

Here, the present invention has been made in view of the above problem, and an object of the present invention is to provide a MOS solid-state imaging device that achieves less video distortion compared to that of a conventional one.

### Solution to Problem

To achieve the above object, a solid-state imaging device according to an embodiment of the present invention includes: pixels arrayed two-dimensionally, each of which outputs an electrical signal in a reset state and an electrical signal in a light-received state; column signal lines each of which corresponds to one of columns of the pixels and transmits an electrical signal in the reset state and an electrical signal in the light-received state, from the corresponding column of the pixels; first holding circuit units each of which corresponds to one of the column signal lines, and holds electrical signals in the reset state and electrical signals in the light-received state that are transmitted from the pixels through the corresponding one of the column signal lines; and first difference circuit units that each output a difference between one of the electrical signals in the reset state and one of the electrical signals in the light-received state that are held by one of the first holding circuit units, in which the first holding circuit units each include pixel-wise holding circuits, the number of which is identical to the number of the pixels provided for the corresponding one of the column signal lines, the pixel-wise holding circuits being able to hold electrical signals in the reset state of the pixels and electrical signals in the light-received state of the pixels.

According to such a configuration, a pixel-wise holding circuit is provided for one pixel. This allows the first holding circuit units to hold signals from all of the pixels at high speed and separately. Therefore, it is possible to read the signals from the pixels and output to the first holding circuits at high speed. As a result, differences in light exposure time between pixels are reduced, as compared to when the function of a conventional focal-plane shutter is used. Therefore, video distortion can be reduced than before.

Moreover, the solid-state imaging device may further include a row selection circuit that (i) selects the pixels on a row basis, causes the selected pixels in a row to output, to the column signal lines, electrical signals in the reset state of the selected pixels and electrical signals in the light-received state of the selected pixels, (ii) simultaneously selects at least two rows of the pixel-wise holding circuits included in the first holding circuit units, and (iii) causes the first difference circuit units to simultaneously output the electrical signals in the reset state and the electrical signals in the light-received state that are held by the selected pixel-wise holding circuits.

According to such a configuration, after signals from pixels are stored in pixel-wise holding circuits, several pixel-wise holding circuits are simultaneously selected and the signals are outputted to the first difference circuit units. Therefore, noise can be averaged and reduced.

Moreover, the solid-state imaging device may further include: second holding circuit units that each hold output from one of the first difference circuit units; and second difference circuit units that each output a difference between a reference signal and output from one of the second holding circuit units.

More specifically, the solid-state imaging device includes the second holding circuit units that each include pixel-wise holding circuits each of which is capable of holding a differential signal indicating a difference between an electrical signal in the reset state and an electrical signal in the light-received state of one of the pixels, and the solid-state imaging device further includes a row selection circuit successively selects at least two rows of the pixel-wise holding circuits included in the second holding circuit units, and to cause the second difference circuit units to output differential signals held by the selected pixel-wise holding circuits.

According to this configuration, differential signals are held by the second holding circuit units, and it is possible to process signals by combining the differential signals.

### Advantageous Effects

As mentioned above, a solid-state imaging device according to the present invention can provide a solid-state imaging device that achieves less video distortion.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a block diagram showing a configuration of a solid-state imaging device according to the first embodiment of the present embodiment.

FIG. 2 is a circuit diagram showing an example of one column and two rows of a pixel circuit unit in a solid-state imaging device according to the first embodiment.

FIG. 3 is a circuit diagram showing an example of one column and two rows of first holding circuit units in a solid-state imaging device according to the first embodiment.

FIG. 4 is a circuit diagram showing an example of one column of first difference circuit units in a solid-state imaging device according to the first embodiment.

FIG. 5 is a timing chart showing major changes in signals along with time change in normal operations of a solid-state imaging device according to the first embodiment.

FIG. 6 is a timing chart showing major changes in signals along with time change in pixel combining operations of a solid-state imaging device according to the first embodiment.

FIG. 7 shows a combined output for two inputs simultaneously applied by the first holding circuit unit 2.

FIG. 8 is a circuit diagram showing an example of one column and two rows of first holding circuit units in a solid-state imaging device according to the modification of the first embodiment.

FIG. 9 is a timing chart showing major changes in signals along with time change in pixel combining operations of a solid-state imaging device according to the second embodiment of the present invention.

FIG. 10 is a block diagram showing a configuration of a solid-state imaging device according to the third embodiment of the present invention.

FIG. 11 is a circuit diagram showing an example of one column and two rows of second holding circuit units in a solid-state imaging device according to the third embodiment.

FIG. 12 is a circuit diagram showing an example of one column of second difference circuit units in a solid-state imaging device according to the third embodiment.

FIG. 13 is a timing chart showing major changes in signals along with time change in pixel combining operations of a solid-state imaging device according to the third embodiment.

FIG. 14 is a circuit diagram showing an example of one column of second difference circuit units in a solid-state imaging device according to the third embodiment.

FIG. 15 is a timing chart showing major changes in signals along with time change in pixel combining operations of a solid-state imaging device according to the third embodiment.

FIG. 16 is a circuit diagram showing an example of a buffer of a solid-state imaging device according to the third embodiment.

FIG. 17 is a circuit diagram showing an example of one column and two rows of second holding circuit units in a solid-state imaging device according to the third embodiment.

FIG. 18 is a timing chart showing major changes in signals along with time change in pixel combining operations of a solid-state imaging device according to the third embodiment.

FIG. 19A shows an outline of a configuration of a camera according to the fourth embodiment of the present invention.

FIG. 19B is a circuit diagram showing an example of one column and one row of first holding circuit units in a solid-state imaging device.

FIG. 19C is a circuit diagram showing an example of one column and two rows of first holding circuit units in a solid-state imaging device.

FIG. 19D is a timing chart showing major changes in signals along with time change in a solid-state imaging device.

FIG. 19E is a circuit diagram showing an example of one column and one row of first holding circuit units in a solid-state imaging device.

FIG. 20 shows a configuration of a pixel signal combining circuit in a conventional solid-state imaging device.

### DESCRIPTION OF EMBODIMENTS

The following describes a solid-state imaging device according to the embodiments of the present invention with reference to the drawings.

It should be noted that in the drawings, the same reference numerals are given to elements representing substantially the same configurations, operations, and effects. Moreover, although connection relationships between structural elements are exemplified to specifically describe the present invention, connection relationships that achieve the functions of the present invention are not limited to the exemplified connection relationships.

### Embodiment 1

The first embodiment of the present invention will be described,

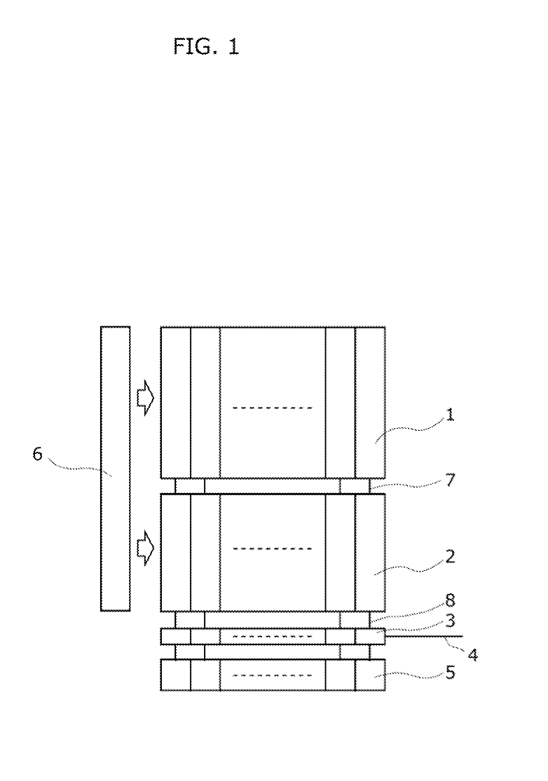

FIG. 1 is a block diagram showing a configuration of a solid-state imaging device according to the present embodiment.

The solid-state imaging device shown in FIG. 1 includes a pixel circuit unit 1, first holding circuit units 2, first difference circuit units 3, an output line 4, column selection circuits 5, a row selection circuit 6, first column signal lines 7, and second column signal lines 8.

The pixel circuit unit 1 includes pixels that are arrayed two-dimensionally (in a matrix) and each of which outputs an electrical signal in a reset state (i.e., a state in which light is not received at a pixel) and an electrical signals in a light-received state (i.e., a state in which light is received at a pixel). The pixel circuit unit 1 outputs, to the first column signal lines 7, electrical signals in the reset state of pixels and electrical signals in the light-received state of the pixels.

The first column signal lines 7 each correspond to one of the columns of pixels, and transmit electrical signals in the reset state and electrical signals in the light-received state, from the corresponding column of pixels.

The first holding circuit units 2 each correspond to one of the first column signal lines 7, and hold electrical signals in the reset state and in the light-received state transmitted from pixels through the corresponding first column signal line 7. The first holding circuit units 2 each include pixel-wise holding circuits, the number of which is identical to the number of pixels provided for the corresponding first column signal line 7. The pixel-wise holding circuits can hold electrical signals in the reset state and in the light-received state of pixels.

The first difference circuit unit 3 outputs a differential signal indicating a difference between an electrical signal in the reset state and an electrical signal in the light-received state which are held by the first holding circuit unit 2. This differential signal is synchronized with the output of the column selection circuit 5 and outputted to the output line 4.

The row selection circuit 6 (i) selects pixels in the pixel circuit unit 1 on a row basis, (ii) causes the selected pixels in a row to output, to the first column signal lines 7, electrical signals in the reset state and light received state of the selected pixels, (iii) selects pixel-wise holding units of several rows at the same time or on a row basis, and (iv) causes the first difference circuit units 3 to output electrical signals in the reset state and the light-received state held at the selected pixel-wise holding units.

It should be noted that the row selection circuit (vertical scanning circuit) 6 and the column selection circuit (horizontal scanning circuit) 5 include circuits capable of scanning such as a shift register and a decoder. For instance, the row selection circuit 6 may include a Y decoder circuit that decodes row addresses each indicating the row of the first holding circuit units 2 to output row selection signals to the first holding circuit units 2. In addition, the column selection circuits 5 may each include a X decoder circuit that decodes a column address indicating the column of one of the first holding circuit units 2 to output a column selection signal to one of the first holding circuit units 2 or one of the first difference circuit units 3. This facilitates random access to the first holding circuit units 2. For instance, it is possible to easily achieve readout of any pixel or area or readout of any rectangular area from an image represented by electrical signals held by the first holding circuit units 2. Moreover, it is possible to easily achieve every K-row readout (K is an integer greater than or equal to 2), every L-column readout (L is an integer greater than or equal to 2), or thinning-out readout (reduction readout) that combined these readouts.

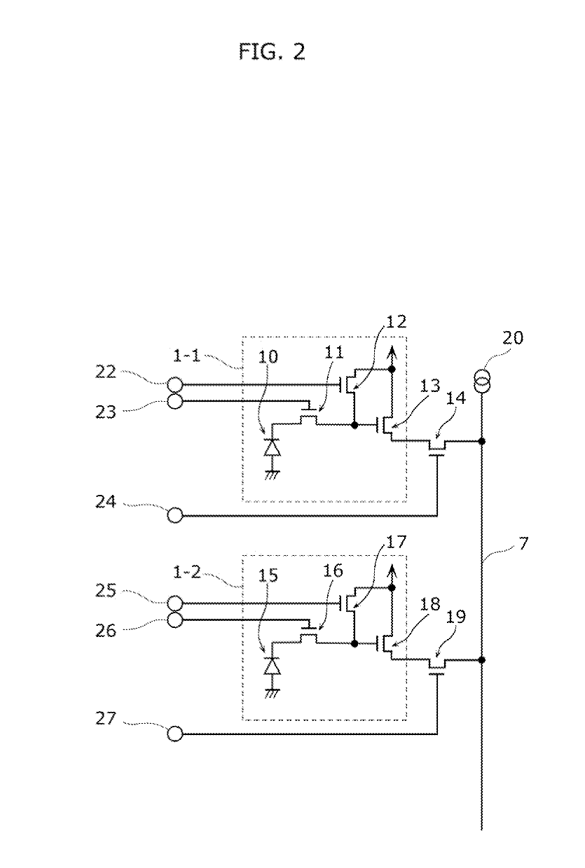

FIG. 2 is a circuit diagram showing a configuration example of the pixel circuit unit 1. It should be noted that FIG. 2 shows the details of one row and two columns of the pixel circuit unit 1. More specifically, FIG. 2 shows the details of the configurations of the pixels (unit cells) 1-1 and 1-2 indicated by broken lines in FIG. 2.

The pixel 1-1 includes a photodiode 10, a transfer MOS transistor 11, a reset MOS transistor 12, and an output MOS transistor 13. As same as the pixel 1-1, the pixel 1-2 includes a photodiode 15, a transfer MOS transistor 16, a reset MOS transistor 17, and an output MOS transistor 18.

In the pixel 1-1, the anode of the photodiode 10 is earthed and, the cathode of the photodiode 10 is connected to the drain of the transfer MOS transistor 11. The source of the transfer MOS transistor 11 is connected to the source of the reset MOS transistor 12 and the gate of the output MOS transistor 13. The gate of the transfer MOS transistor 11 is connected to a terminal 23. The connection area of the gate of the output MOS transistor 13, the source of the reset MOS transistor 12, and the source of the transfer MOS transistor 11 forms diffusion capacitance called floating diffusion (hereinafter referred to as FD). The drain of the reset MOS transistor 12 is connected to a power supply, and the gate of the reset MOS transistor 12 is connected to a terminal 22. The drain of the output MOS transistor 13 is connected to the power supply, and the source of the output MOS transistor 13 is connected to the drain of a row selection MOS transistor 14. A current source 20 is connected to the first column signal line 7. When the gate of the row selection MOS transistor 14 is connected to a terminal 24, and the row selection. MOS transistor 14 is conducting, the row selection MOS transistor 14 forms a source follower circuit together with the output MOS transistor 13 and the current source 20.

Also in the pixel 1-2, the anode of the photodiode 15 is earthed and, the cathode of the photodiode 15 is connected to the drain of the transfer MOS transistor 16. The source of the transfer MOS transistor 16 is connected to the source of the reset MOS transistor 17 and the gate of the output. MOS transistor 18. The gate of the transfer MOS transistor 16 is connected to a terminal 26. The connection area of the gate of the output MOS transistor 18, the source of the reset MOS transistor 17, and the source of the transfer MOS transistor 16 forms diffusion capacitance called FD. The drain of the reset MOS transistor 17 is connected to a power supply, and the gate of the reset MOS transistor 17 is connected to a terminal 25. The drain of the output MOS transistor 18 is connected to the power supply, and the source of the output MOS transistor 18 is connected to the drain of a row selection MOS transistor 19. When the gate of the row selection MOS transistor 19 is connected to a terminal 27, and the row selection MOS transistor 19 is conducting, the row selection MOS transistor 19 forms a source follower circuit together with the output MOS transistor 18 and the current source 20.

The output from the pixels 1-1 and 1-2 is connected to the first column signal line 7 via the row selection MOS transistors 14 and 19. The first column signal line 7 is connected to one of the first holding circuit units 2 in FIG. 1.

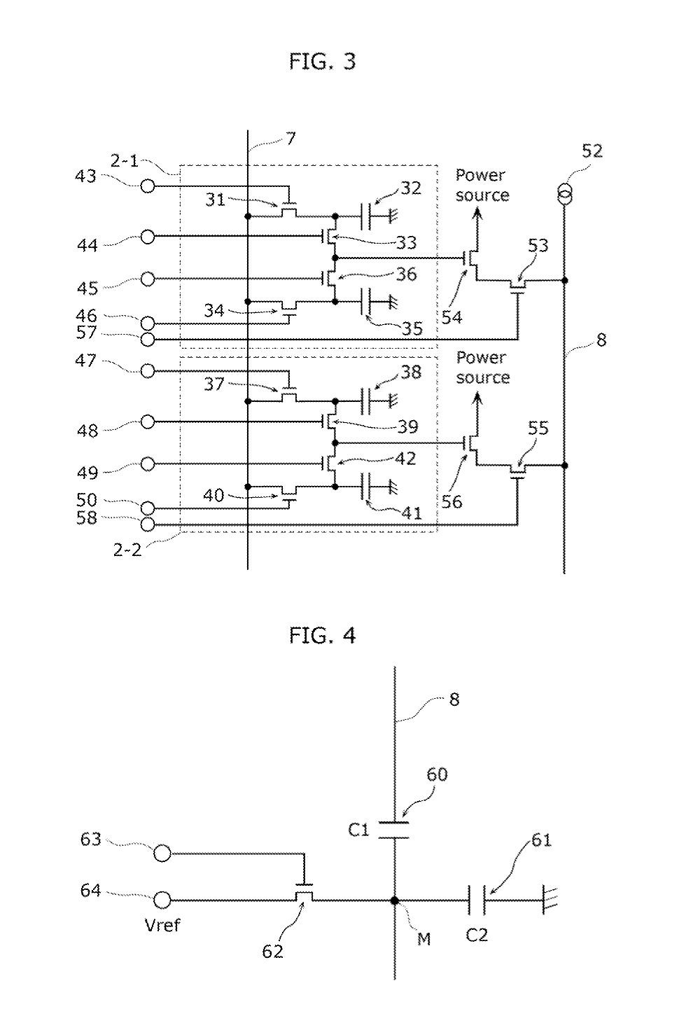

FIG. 3 is a circuit diagram showing a configuration of the first holding circuit unit 2. It should be noted that FIG. 3 shows the details of one column and two rows of the first holding circuit units 2. More specifically, FIG. 3 shows the details of pixel-wise holding circuits 2-1 and 2-2 that are provided for one of the columns of pixels and are indicated by broken lines in FIG. 3.

The pixel-wise holding circuit 2-1 includes MOS transistors 31, 33, 34, and 36, and capacitors 32 and 35. The drain of the MOS transistor 31 is connected to the first column signal line 7. The source of the MOS transistor 31 is connected to one terminal of the capacitor 32 and the drain of the MOS transistor 33. The gate of the MOS transistor 31 is connected to a terminal 43. The other terminal of the capacitor 32 is earthed. The source of the MOS transistor 33 is connected to the gate of a MOS transistor 54, and the gate of the MOS transistor 33 is connected to a terminal 44. The drain of the MOS transistor 34 is connected to the first column signal line 7. The source of the MOS transistor 34 is connected to one terminal of the capacitor 35 and the drain of the MOS transistor 36. The gate of the MOS transistor 34 is connected to a terminal 46. The other terminal of the capacitor 35 is earthed. The source of the MOS transistor 36 is connected to the gate of a MOS transistor 54, and the gate of the MOS transistor 36 is connected to a terminal 45. The drain of the MOS transistor 54 is connected to a power supply, and the source of the MOS transistor 54 is connected to the drain of a row selection MOS transistor 53. The gate of the row selection MOS transistor 53 is connected to a terminal 57, and the source of the row selection MOS transistor 53 is connected to the second column signal line 8.

The pixel-wise holding circuit 2-2 includes MOS transistors 37, 39, 40, and 42, and capacitors 38 and 41. The drain of the MOS transistor 37 is connected to the first column signal line 7. The source of the MOS transistor 37 is connected to one terminal of the capacitor 38 and the drain of the MOS transistor 39. The gate of the MOS transistor 37 is connected to a terminal 47. The other terminal of the capacitor 38 is earthed. The source of the MOS transistor 39 is connected to the gate of a MOS transistor 56, and the gate of the MOS transistor 39 is connected to a terminal 48. The drain of the MOS transistor 40 is connected to the first column signal line 7. The source of the MOS transistor 40 is connected to one terminal of the capacitor 41 and the drain of the MOS transistor 42. The gate of the MOS transistor 40 is connected to a terminal 50. The other terminal of the capacitor 41 is earthed. The source of the MOS transistor 42 is connected to the gate of the MOS transistor 56, and the gate of the MOS transistor 42 is connected to a terminal 49. The drain of the MOS transistor 56 is connected to a power supply, and the source of the MOS transistor 56 is connected to the drain of a row selection MOS transistor 55. The gate of the row selection MOS transistor 55 is connected to a terminal 58, and the source of the row selection MOS transistor 55 is connected to the second column signal line 8.

A current source 52 and the MOS transistor 54 form a source follower when the corresponding row selection MOS transistor 53 is conducting. The current source 52 and the MOS transistor 56 form a source follower when the corresponding 55 is conducting.

FIG. 4 is a circuit diagram showing a configuration of the first difference circuit unit 3. It should be noted that FIG. 4 shows the details of a configuration of one column of the first difference circuit units 3 each of which is provided for one of the first holding circuit units 2.

The first difference circuit unit 3 is connected to the second column signal line 8 to which the output from the first holding circuit units 2 is transmitted, and includes capacitor 60 having a capacitance value C1, capacitor 61 having a capacitance value C2, and a MOS transistor 62. One terminal of the capacitor 60 is connected to the second column signal line 8. The other terminal of the capacitor 60 is connected to the source of the MOS transistor 62 and the connection node (the point M in FIG. 4) of one terminal of the capacitor 61. One terminal of the capacitor 61 is connected to the point M, and the other terminal is earthed. The source of the MOS transistor 62 is connected to the point M. The drain of the MOS transistor 62 is connected to a terminal 64. The gate of the MOS transistor 62 is connected to a terminal 63. A bias voltage is applied to the terminal 64.

The following describes operations of a solid-state imaging device according to the present embodiment, with reference to FIGS. 2, 3, 4, and 5. First, normal operations of the solid-state imaging device will be described.

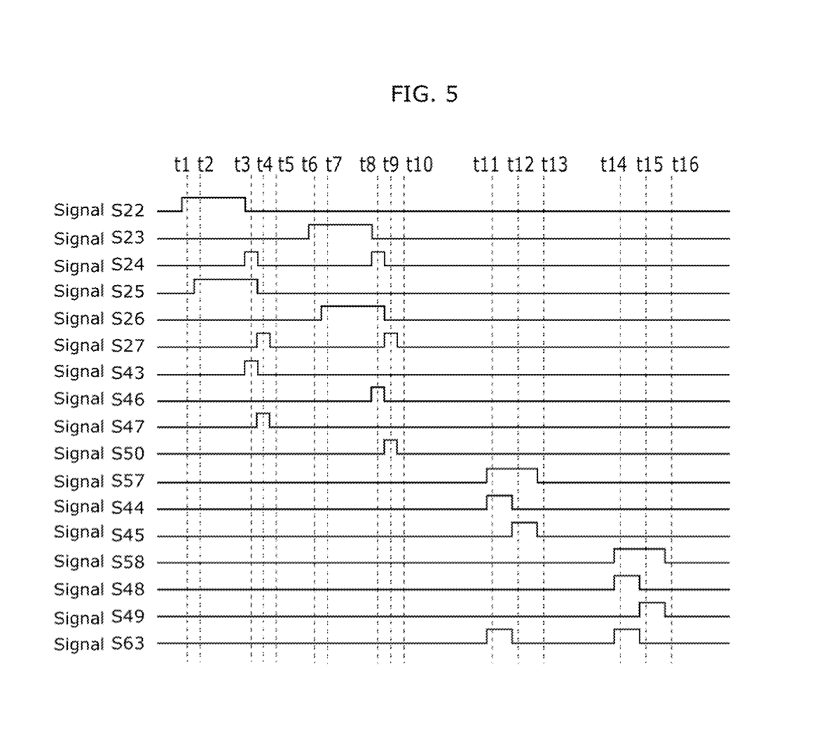

FIG. 5 is a timing chart showing major change in signals along with time change in the solid-state imaging device according to the present embodiment. FIG. 5 shows control signals applied to terminals of the pixel circuit unit 1 in FIG. 2, the first holding circuit unit 2 in FIG. 3, and the first difference circuit unit 3 in FIG. 4.

It should be noted that in FIG. 5, each control signal is named in such a way that “S” is given before the reference numeral of a terminal to which a signal is applied. Therefore, a signal S22 is applied to the terminal 22 and inputted to the gate of the reset MOS transistor 12. A signal S23 is applied to the terminal 23 and inputted to the gate of the transfer MOS transistor 11. A signal S24 is applied to the terminal 24 and inputted to the gate of the row selection MOS transistor 14. A signal S25 is applied to the terminal 25 and inputted to the gate of the reset MOS transistor 17. A signal S26 is applied to the terminal 26 and inputted to the gate of the transfer MOS transistor 16. A signal S27 is applied to the terminal 27 and inputted to the gate of the row selection MOS transistor 19. A signal S43 is applied to the terminal 43 and inputted to the gate of the MOS transistor 31. A signal S46 is applied to the terminal 46 and inputted to the gate of the MOS transistor 34. A signal S47 is applied to the terminal 47 and inputted to the gate of the MOS transistor 37. A signal S50 is applied to the terminal 50 and inputted to the gate of the MOS transistor 40. A signal S57 is applied to the terminal 57 and inputted to the gate of the row selection MOS transistor 53. A signal S44 is applied to the terminal 44 and inputted to the gate of the MOS transistor 33. A signal S45 is applied to the terminal 45 and inputted to the gate of the MOS transistor 36. A signal S58 is applied to the terminal 58 and inputted to the gate of the row selection MOS transistor 55. A signal S48 is applied to the terminal 48 and inputted to the gate of the MOS transistor 39. A signal S49 is applied to the terminal 49 and inputted to the gate of the MOS transistor 42. A signal S63 is applied to the terminal 63 and inputted to the gate of the MOS transistor 62.

The signal S22 becomes “HIGH” at a time point t1 in FIG. 5. The gate of the reset MOS transistor 12 in the pixel 1-1 is caused to “HIGH”, so that the reset MOS transistor 12 is conducting. Thus, the FD in the pixel 1-1 is connected to the power supply and is brought to a reset state.

The signal S25 becomes “HIGH” at a time point t2. The gate of the reset MOS transistor 17 in the pixel 1-2 is caused to “HIGH”, so that the reset MOS transistor 17 is conducting. Thus, the ED in the pixel 1-2 is connected to the power supply and is brought to a reset state. At the time point t2, the reset MOS transistor 12 in the pixel 1-1 and the reset MOS transistor 17 in the pixel 1-2 are both conducting, and the FD in the pixel 1-1 and the ED in the pixel 1-2 are both in the reset state.

At a time point t3, the signal S22 becomes “LOW”, the signal S24 becomes “HIGH”, and the signal S43 becomes “HIGH”. Thus the row selection MOS transistor 14 becomes conductive. Therefore, the voltage of the FD in the pixel 1-1 is transmitted to the first column signal line 7. Moreover, the gate of the MOS transistor 31 in the first holding circuit unit 2 becomes “HIGH”, and thus the MOS transistor 31 becomes conductive. Therefore, the voltage of the FD is transmitted to and held in the capacitor 32.

At a time point t4, the signal S25 becomes “LOW”, the signal S27 becomes “HIGH”, and the signal S47 becomes “HIGH”. Thus, the row selection MOS transistor 19 becomes conductive. Therefore, the voltage of the FD in the pixel 1-2 is transmitted to the first column signal line 7. Moreover, the gate of the MOS transistor 37 in the first holding circuit unit 2 becomes “HIGH”, and thus the MOS transistor 37 becomes conductive. Therefore, the voltage of the FD is transmitted to and held in the capacitor 38.

At a time point t5, all signals become “LOW”. At the time point t5, electrical signals in the reset state of the FD in the pixel 1-1 are held in the capacitor 32 in the first holding circuit unit 2, and the electrical signals in the reset state of the FD in the pixel 1-2 are held in the capacitor 38 in the first holding circuit unit 2.

At a time point t6, the signal S23 becomes “HIGH” The gate of the transfer MOS transistor 11 in the pixel 1-1 is caused to “HIGH”, so that the transfer MOS transistor 11 is conducting. Thus, signals obtained after the photodiode 10 received light is transferred to the ED.

At a time point t7, the signal S26 becomes “HIGH”. The gate of the transfer MOS transistor 16 in the pixel 1-2 is caused to “HIGH”, so that the transfer MOS transistor 16 is conducting. Thus, signals after the photodiode received light is transferred to the FD. At this time point, the transfer MOS transistor 11 in the pixel 1-1 and the transfer MOS transistor 16 in the pixel 1-2 are both conducting, and the FD in the pixel 1-1 and the FD in the pixel 1-2 are both in the light-received state.

At a time point t8 the signal S23 becomes “LOW”, the signal S24 becomes “HIGH”, and the signal S46 becomes “HIGH”. Thus, the row selection MOS transistor 14 becomes conductive. Therefore, the voltage of the FD in the pixel 1-1 is transmitted to the first column signal line 7. Moreover, the gate of the MOS transistor 34 in the first holding circuit unit 2 becomes “HIGH”, and thus the MOS transistor 34 becomes conductive. Therefore, the voltage of the FD is transmitted to and held in the capacitor 35.

At a time point t9 the signal S26 becomes “LOW” the signal S27 becomes “HIGH”, and the signal S50 becomes “HIGH”. Thus, the row selection MOS transistor 19 becomes conductive. Therefore, the voltage of the FD in the pixel 1-2 is transmitted to the first column signal line 7. Moreover, the gate of the MOS transistor 40 in the first holding circuit unit 2 becomes “HIGH”, and thus the MOS transistor 40 becomes conductive. Therefore, the voltage of the FD is transmitted to and held in the capacitor 41.

At a time point t10, all signals become “LOW”. At the time point t10, electrical signals in the light-received state of the FD in the pixel 1-1 are held in the capacitor 35 in the first holding circuit unit 2, and the electrical signals in the light-received state of the FD in the pixel 1-2 are held in the capacitor 41 in the first holding circuit unit 2.

At a time point t11, the signals S57, S44, and S63 become “HIGH”. Thus, the row selection MOS transistor 53 and the MOS transistor 33 in the first holding circuit unit 2 become conductive. Therefore, the voltage of the capacitor 32 is transmitted to the second column signal line 8. This voltage will be referred to as “Vrs1”. Moreover, when the MOS transistor 62 in the first difference circuit unit 3 is conducting, the Point M in FIG. 4 is “Vref”. Therefore, “Vrs1-Vref” is set in the capacitor 60.

At a time point t12, the signals S57 and 545 become “HIGH”. Thus, the row selection MOS transistor 53 and the MOS transistor 36 in the first holding circuit unit 2 become conductive. Therefore, the voltage of the capacitor 35 is transmitted to the second column signal line 8. This voltage will be referred to as “Vsg1”. Since the MOS transistor 62 of the first difference circuit unit 3 is not conducting, a voltage change at the M point is defined by a voltage change in the second column signal line 8 and the capacitance ratio of the capacitor 60 to the capacitor 61. The voltage change in the second column signal line 8 is “Vrs1−Vsg1”, and the coefficient of capacitance is “C1/(C1+C2)”. Therefore, a voltage change at the Point M is “C1/(C1+C2)×(Vrs1−Vsg1)”.

At a time point t14, the signals S58, 548, and 563 become “HIGH”. Thus, the row selection MOS transistor 55 and the MOS transistor 39 in the first holding circuit unit 2 become conductive. Therefore, the voltage of the capacitor 38 is transmitted to the second column signal line 8. This voltage will be referred to as “Vrs2”. Moreover, when the MOS transistor 62 in the first difference circuit unit 3 is conducting, the Point M in FIG. 4 is “Vref”. Therefore, “Vrs2−Vref” is set in the capacitor 60.

At a time point t15, the signals S58 and S49 become “HIGH”. Thus, the row selection MOS transistor 55 and the MOS transistor 42 in the first holding circuit unit 2 become conductive. Therefore, the voltage of the capacitor 41 is transmitted to the second column signal line 8. This voltage will be referred to as “Vsg2”. Since the MOS transistor 62 of the first difference circuit unit 3 is not conducting, a voltage change at the M point is defined by a voltage change in the second column signal line 8 and the capacitance ratio of the capacitor 60 to the capacitor 61. The voltage change in the second column signal line 8 is “Vrs2−Vsg2”, and the coefficient of capacitance is “C1/(C1+C2)”. Therefore, a voltage change at the Point. M is “C1/(C1+C2)×(Vrs2−Vsg2)”.

As described as above, in normal operations, differential signals between the electrical signals in the reset state of pixels and the electrical signals in the light-received state of the pixels are outputted to the output line 4 on a row basis.

The following describes the pixel combining operations of a solid-state imaging device according to the present embodiment.

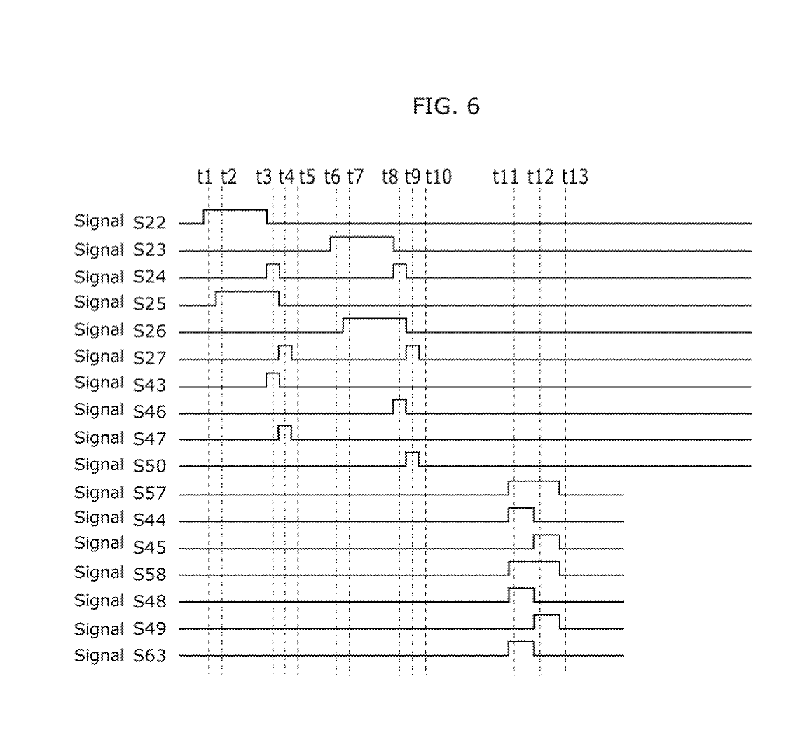

FIG. 6 is a timing chart showing major change in signals along with time change in the solid-state imaging device according to the present embodiment. FIG. 6 shows control signals applied to the terminals of the pixel circuit unit 1 in FIG. 2, the first holding circuit unit 2 in FIG. 3, and the first difference circuit unit 3 in FIG. 4.

It should be noted that in FIG. 6, each control signal is named in such a way that “S” is given before the reference numeral of a terminal to which a signal is applied.

The operations in FIG. 6 during the time points t1 to t10 are the same as those shown in FIG. 5. The difference is in that the signals S58, S48, and S49 which are applied during the time points t14 to t16 in FIG. 5 are applied during the time points t11 to t13. The following mainly describes operations different from those shown in FIG. 5.

At the time point t11, the signals S57, S44, S58, S48, and S63 become “HIGH”. Thus, the row selection MOS transistors 53 and 55 and the MOS transistors 33 and 39 in the first holding circuit unit 2 become conductive. Therefore, the combined voltage of the capacitors 32 and 38 is transmitted to the second column signal line 8. The combined voltage will be referred to as “Vrs₁₊₂”. Moreover, when the MOS transistor 62 in the first difference circuit unit 3 is conducting, the Point M in FIG. 4 is “Vref”. Therefore, “Vrs₁₊₂−Vref” is set in the capacitor 60.

At the time point t12, the signals S57, S45, S58, and S49 become “HIGH”. Thus, the row selection MOS transistors 53 and 55 and the MOS transistors 36 and 42 in the first holding circuit unit 2 become conductive. Therefore, the combined voltage of the capacitors 35 and 41 is transmitted to the second column signal line 8. The combined voltage will be referred to as “Vsg₁₊₂”. Since the MOS transistor 62 of the first difference circuit unit 3 is not conducting, a voltage change at the M point is defined by a voltage change in the second column signal line 8 and the capacitance ratio of the capacitor 60 to the capacitor 61. The voltage change in the second column signal line 8 is “Vrs₁₊₂−Vsg₁₊₂”, the coefficient of capacitance is “C1/(C1+C2)”. Therefore, the voltage change at the Point M is “C1/(C1+C2)×Vrs₁₊₂−Vsg₁₊₂”.

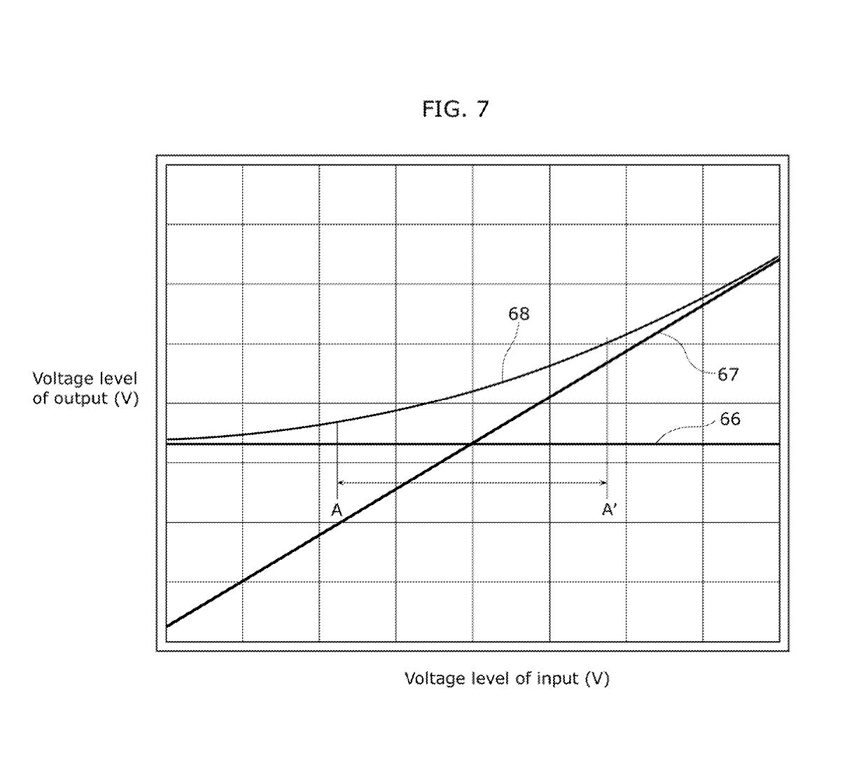

FIG. 7 is a graph of a combined output for two inputs simultaneously applied by the first holding circuit unit 2 in FIG. 3. It should be noted that FIG. 7 shows an input voltage level in the horizontal axis and an output voltage level in the vertical axis.

In FIG. 7, when an input 66 is a constant voltage signal and an input 67 is a simple-upward voltage signal, an output 68 accurately represents the combination of the two inputs (the inputs 66 and 67) in the range A-A′. Thus, in pixel combining operations according to the preset embodiment, differential signals between the electrical signals in the reset state of pixels and the electrical signals in the light-received state of the pixels are outputted on a two-row basis to the output line 4.

As mentioned above, according to the solid-state imaging device of the present embodiment, the first holding circuit units 2 each include pixel-wise holding circuits each correspond to one of the pixels. This allows the first holding circuit units 2 to simultaneously and independently hold signals from the pixels in the pixel circuit unit 1. Therefore, the pixel circuit unit 1 can, at a high speed, transmit electrical signals in the reset state and in the light-received state to the first holding circuit units 2. As a result, differences in light exposure time between pixels are reduced, as compared to when the function of a conventional focal-plane shutter is used. Therefore, video distortion can be reduced.

Moreover, according to a solid-state imaging device of the present embodiment, pixels are combined when electrical signals are transmitted from the first holding circuit unit 2 to the output line 4. Therefore, the amount of data outputted from the output line 4 decreases. This achieves high-speed signal processing.

Moreover, according to a solid-state imaging device of the present embodiment, electrical signals in the first holding circuit unit 2 are simultaneously outputted to the first difference circuit unit 3. Therefore, noise can be averaged and reduced.

### Modification of Embodiment 1

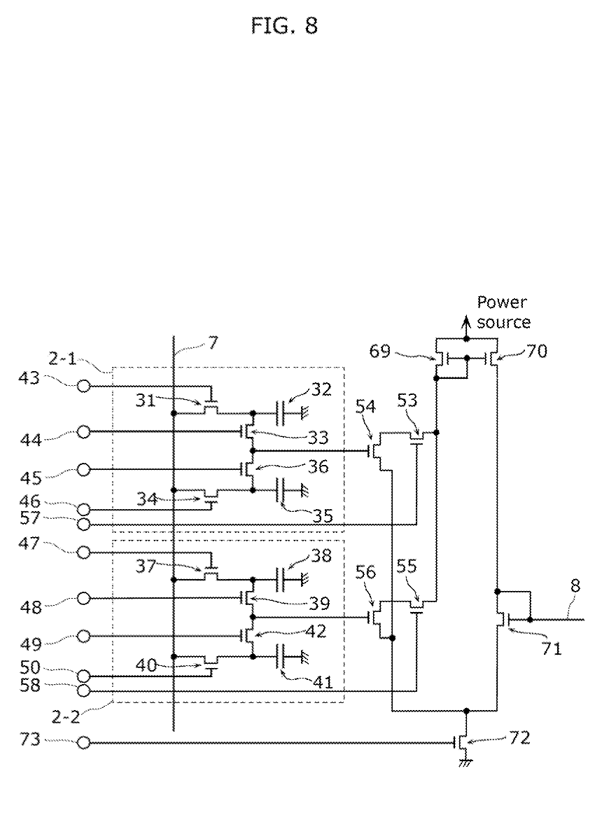

FIG. 8 is a circuit diagram showing a configuration of the first holding circuit unit 2 according to a modification of the first embodiment. It should be noted that FIG. 8 shows the details of one column and two rows of the first holding circuit units 2. More specifically, FIG. 8 shows the details of pixel-wise holding circuits 2-1 and 2-2 that are provided for one of the columns of pixels and are indicated by broken lines in FIG. 8.

As an output form, the first holding circuit unit 2 in FIG. 8 employ a buffer type while the first holding circuit unit 2 in FIG. 3 employ a source follower type. The configurations of the pixel-wise holding circuits 2-1 and 2-2 and the configuration of each signal terminal are the same as those shown in FIG. 3. Therefore, the same reference numerals are used and descriptions will be omitted here. The MOS transistor 54, the row selection MOS transistor 53, the MOS transistor 56, and the row selection MOS transistor 55 are also the same as those shown in FIG. 3.

MOS transistors 69 and 70 form a current mirror circuit. The drain of the MOS transistor 69 is connected to a power source. The source of the MOS transistor 69 is connected to the sources of the row selection MOS transistors 53 and 55 and the gate of the MOS transistor 69 itself. The drain of the MOS transistor 70 is connected to the power supply. The gate of the MOS transistor 70 is connected to the gate of the MOS transistors 69. The source of the MOS transistor 70 is connected to the drain of a MOS transistor 71. The gate of the MOS transistor 71 is connected to the drain of the MOS transistor 71, and the source of the MOS transistor 71 is connected to the drain of the MOS transistor 72. The gate of the MOS transistor 71 is connected to the second column signal line 8. The sources of the MOS transistors 54 and 56 are interconnected, and are connected to the drain of the MOS transistor 72. The source of the MOS transistor 72 is earthed, and the gate of the MOS transistor 72 is connected to a terminal 73. A bias voltage is applied to a terminal 73.

The operations of the first holding circuit unit 2 in FIG. 8 are similar to those shown in FIG. 6. Therefore, description will be omitted here. When the first holding circuit unit 2 configured as FIG. 8 is used, the pixel combining operations shown in FIG. 6 can be achieved.

As mentioned above, a solid-state imaging device of the present modification can achieve high-speed signal processing while reducing video distortion. Moreover, noise can be reduced.

### Embodiment 2

The second embodiment of the present invention will be described.

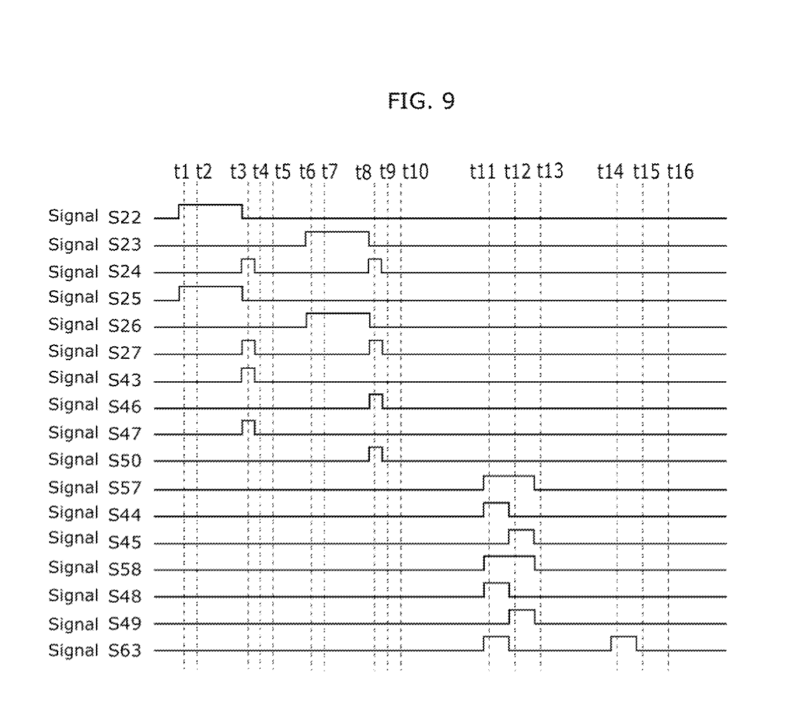

FIG. 9 is a timing chart showing major changes in signals along with time change in a solid-state imaging device according to the present embodiment. FIG. 9 shows control signals applied to the terminals of the pixel circuit unit 1 in FIG. 2, the first holding circuit unit 2 in FIG. 3, and the first difference circuit unit 3 in FIG. 4.

Signals S25, S26, S27, S47, and S50 in FIG. 9 are different from those shown in FIG. 6. The signals S25, S26, S27, S47 and S50 become “HIGH” or “LOW” at the same timing as the signals S22, S23, S24, S43, and S46 in FIG. 6, respectively. Therefore, the reset MOS transistor 12, the transfer MOS transistor 11, and the row selection MOS transistor 14 that are shown in the pixel 1-1 in FIG. 2 operate at the same timing as the reset MOS transistor 17, the transfer MOS transistor 16, and the row selection MOS transistor 19 that are shown in the pixel 1-2 in FIG. 2, respectively. In other words, the row selection circuit 6 selects pixels on a several-row basis, and electrical signals in the reset state and the light-received state from pixels of the selected several rows are outputted to the first column signal line 7. Thus, the electrical signals in the reset state of the pixels 1-1 and 1-2 are outputted to the first column signal line 7 at the same time, and the electrical signals in the light-received state of the pixels 1-1 and 1-2 are outputted to the first column signal line 7 at the same time. This means that electrical signals in the reset state and electrical signals in the light-received state are individually combined on a one-column and two-row basis and outputted to the first column signal line 7.

According to the operations in FIG. 9, electrical signals in the reset state from the pixels 1-1 and 1-2 are combined in the first holding circuit unit 2 in FIG. 3 and held both in the capacitor 32 in the pixel-wise holding circuit 2-1 and the capacitor 38 in the pixel-wise holding circuit 2-2. Moreover, electrical signals in the light-received sate from the pixels 1-1 and 1-2 are combined and held both in the capacitor 35 in the pixel-wise holding circuit 2-1 and the capacitor 41 in the pixel-wise holding circuit 2-2. In other words, the combined electrical signal in the reset state of two rows of the pixels 1-1 and 1-2 is held in the capacitor 32 in the pixel-wise holding circuit 2-1 and the capacitor 38 in the pixel-wise holding circuit 2-2, and the combined electrical signal in the light-received state of two rows of the pixels 1-1 and 1-2 is held in the capacitor 35 in the pixel-wise holding circuit 2-1 and the capacitor 41 in the pixel-wise holding circuit 2-2.

In the readout from the time points t11 to t13, two rows of the pixel-wise holding circuits 2-1 and 2-2 are selected at the same time and combined, and signals held by the holding circuits 2-1 and 2-2 are readout. When two signals from different pixels but in the same state are combined and readout in such a way, random noise decreases to (1/√2).

As mentioned above, a solid-state imaging device of the present embodiment can achieve high-speed signal processing while reducing video distortion. Moreover, noise can be reduced.

### Embodiment 3

The third embodiment of the present invention will be described.

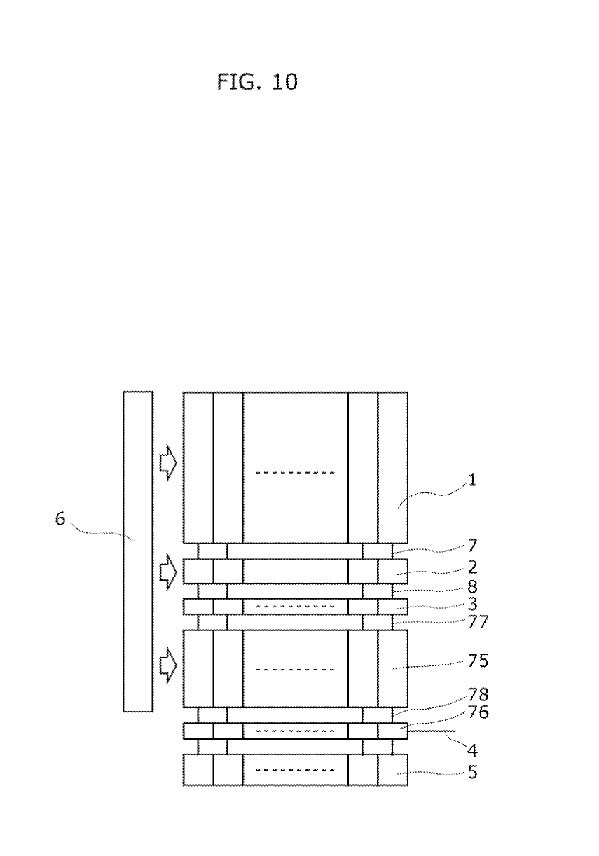

FIG. 10 is a block diagram showing a configuration of a solid-state imaging device according to the present embodiment.

The solid-state imaging device in FIG. 10 includes the pixel circuit unit 1, the first holding circuit units 2, the first difference circuit units 3, the output line 4, the column selection circuits 5, the row selection circuit 6, the first column signal lines 7, and the second column signal lines 8 that are the same as those shown in FIG. 1. The difference from the solid-state imaging device in FIG. 1 is in that second holding circuit units 75, second difference circuit units 76, third column signal lines 77, and fourth column signal lines 78 are provided between the first difference circuit units 3 and the column selection circuits 5.

Electrical signals in a reset state and electrical signals a light-received state that are held in the first holding circuit units 2 are applied to the first difference circuit units 3, and differential signals outputted from the first difference circuit units 3 are held by the second holding circuit units 75. The differential signal is readout to the output line 4 by applying a reference signal and a holding signal of the second holding circuit unit 75 to the second difference circuit unit 76.

The second holding circuit unit 75 holds output from the first difference circuit unit 3. The second difference circuit unit 76 outputs a difference between the output from the second holding circuit unit 75 and a reference signal. The second holding circuit unit 75 includes several pixel-wise holding circuits that can hold a differential signal between an electrical signal in the reset state of a pixel and an electrical signal in the light-received state of the pixel. The row selection circuit 6 successively selects pixel-wise holding circuits in the second holding circuit unit 75, and causes the second holding circuit unit 76 to output the differential signals held by the selected pixel-wise holding circuits.

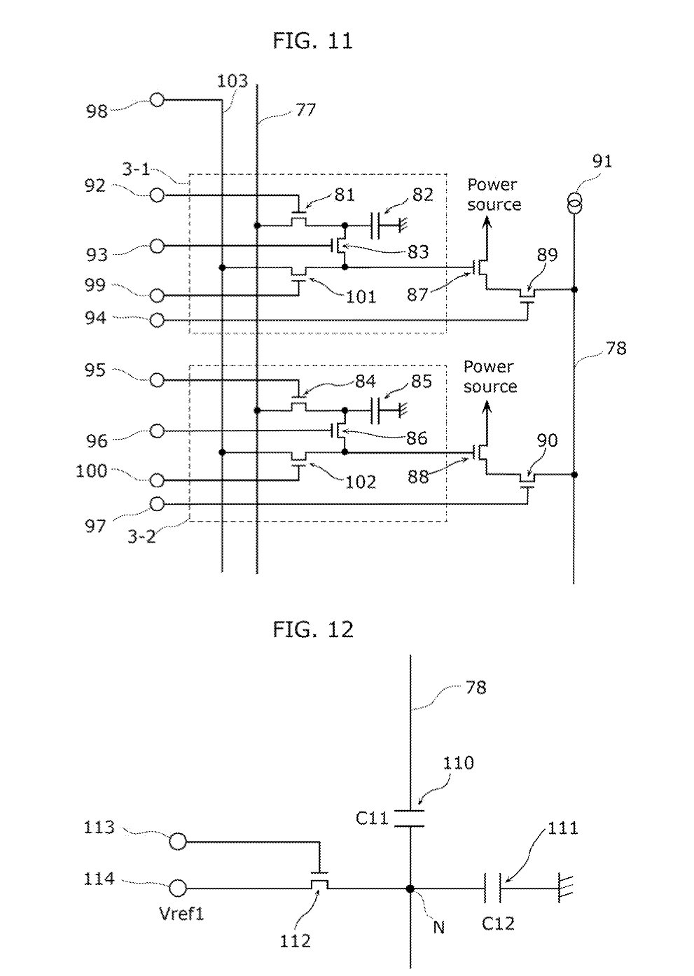

FIG. 11 is a circuit diagram showing a configuration of the second holding circuit unit 75. It should be noted that FIG. 11 shows the details of one column and two rows of the second holding circuit units 75. More specifically, FIG. 11 shows the details of pixel-wise holding circuits 3-1 and 3-2 that are provided for one of the first difference circuit units 3 and are indicated by broken lines in FIG. 11.

The pixel-wise holding circuit 3-1 includes MOS transistors 81, 83, and 101, and a capacitor 82.

The drain of the MOS transistor 81 is connected to the third column signal line 77. The source of the MOS transistor 81 is connected to one terminal of the capacitor 82 and the drain of the MOS transistor 83. The gate of the MOS transistor 81 is connected to a terminal 92. The other terminal of the capacitor 82 is earthed. The source of the MOS transistor 83 is connected to the gate of the MOS transistor 87, and the gate of the MOS transistor 83 is connected to a terminal 93. The drain of the MOS transistor 101 is connected to a reference voltage line 103. The gate of the MOS transistor 101 is connected to a terminal 99. The source of the MOS transistor 101 is connected to the gate of the MOS transistor 87. The drain of the MOS transistor 87 is connected to a power supply, and the source of the MOS transistor 87 is connected to the drain of a row selection MOS transistor 89. The gate of the row selection MOS transistor 89 is connected to a terminal 94, and the source of the row selection MOS transistor 89 is connected to the fourth column signal line 78.

The pixel-wise holding circuit 3-2 includes MOS transistors 84, 86, and 102, and a capacitor 85.

The drain of the MOS transistor 84 is connected to the third column signal line 77. The source of the MOS transistor 84 is connected to one terminal of the capacitor 85 and the drain of the MOS transistor 86. The gate of the MOS transistor 84 is connected to a terminal 95. The other terminal of the capacitor 85 is earthed. The source of the MOS transistor 86 is connected to the gate of the MOS transistor 88, and the gate of the MOS transistor 86 is connected to a terminal 96. The drain of the MOS transistor 102 is connected to the reference voltage line 103. The gate of the MOS transistor 102 is connected to a terminal 100. The source of the MOS transistor 102 is connected to the gate of the MOS transistor 88. The drain of the MOS transistor 88 is connected to a power supply, and the source of the MOS transistor 88 is connected to the drain of a row selection MOS transistor 90. The gate of the row selection MOS transistor 90 is connected to a terminal 97, and the source of the row selection. MOS transistor 90 is connected to the fourth column signal line 78.

A current source 91 and the MOS transistor 87 form a source follower when the corresponding row selection MOS transistor 89 is conducting. The current source 91 and the MOS transistor 88 form a source follower when the corresponding row selection MOS transistor 90 is conducting. The reference voltage line 103 is connected to a terminal 98.

FIG. 12 is a circuit diagram showing a configuration of the second difference circuit unit 76. It should be noted that the second difference circuit unit 76 in FIG. 12 has a circuit configuration similar to that of the first difference circuit unit 3 in FIG. 4. Moreover, FIG. 12 shows a detailed configuration of one column of the first difference circuits 76 provided for one of the second holding circuit units 75.

The second difference circuit unit 76 is connected to the fourth column signal line 78 to which output from the second holding circuit unit 75 is transmitted, and includes a capacitor 110 having a capacitance value C11, a capacitor 111 having a capacitance value C12, and a MOS transistor 112. One terminal of the capacitor 110 is connected to the fourth column signal line 78, and the other terminal is connected to the source of the MOS transistor 112 and a connection node of one terminal of the capacitor 111 (a point N in FIG. 12). One terminal of the capacitor 111 is connected to the point N, and the other terminal is earthed. The source of the MOS transistor 112 is connected to the point N, and the gate of the MOS transistor 112 is connected to a terminal 113. A bias voltage is applied to a terminal 114.

The following describes the operations of a solid-state imaging device according to the present embodiment, with reference to FIGS. 3, 4, 11, and 12.

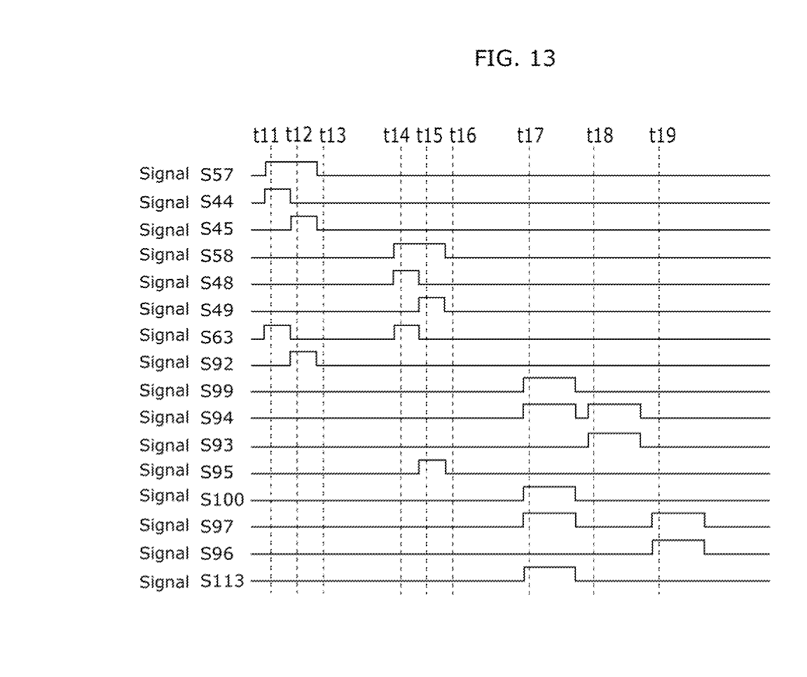

FIG. 13 is a timing chart showing major changes in signals along with time change in pixel combining operations of the solid-state imaging device according to the present embodiment. FIG. 13 shows control signals applied to the terminals of the first holding circuit unit 2 in FIG. 3, the first difference circuit unit 3 in FIG. 4, the second holding circuit unit 75 in FIG. 11, and the second difference circuit unit 76 in FIG. 12.

It should be noted that in FIG. 13, each control signal is named in such a way that “S” is given before the reference numeral of a terminal to which a signal is applied. Therefore, the signal S57 is applied to the terminal 57 and inputted to the gate of the row selection MOS transistor 53. The signal S44 is applied to the terminal 44 and inputted to the gate of the MOS transistor 33. The signal S45 is applied to the terminal 45 and inputted to the gate of the MOS transistor 36. The signal S58 is applied to the terminal 58 and inputted to the gate of the row selection MOS transistor 55. The signal S48 is applied to the terminal 48 and inputted to the gate of the MOS transistor 39. The signal S49 is applied to the terminal 49 and inputted to the gate of the MOS transistor 42. The signal S63 is applied to the terminal 63 and inputted to the gate of the MOS transistor 62. A signal S92 is applied to the terminal 92 and inputted to the gate of the MOS transistor 81. A signal S99 is applied to the terminal 99 and inputted to the gate of the MOS transistor 101. A signal S94 is applied to the terminal 94 and inputted to the gate of the row selection MOS transistor 89. A signal S93 is applied to the terminal 93 and inputted to the gate of the MOS transistor 83. A signal S95 is applied to the terminal 95 and inputted to the gate of the MOS transistor 84. A signal S100 is applied to the terminal 100 and inputted to the gate of the MOS transistor 102. A signal S97 is applied to the terminal 97 and inputted to the gate of the row selection MOS transistor 90. A signal S96 is applied to the terminal 96 and inputted to the gate of the MOS transistor 86. A signal S113 is applied to the terminal 113 and inputted to the gate of the MOS transistor 112.

In FIG. 13 and FIG. 6, the operations from the time points t1 to t10 are the same. Therefore, the explanation will be omitted below. By the time point t10, electrical signals in the reset state from the pixel circuit unit 1 are stored in the capacitor 32 of the pixel-wise holding circuit 2-1 and the capacitor 38 of the pixel-wise holding circuit 2-2 in FIG. 3, and electrical signals in the light-received state are stored in the capacitor 35 of the pixel-wise holding circuit 2-1 and the capacitor 41 of the pixel-wise holding circuit 2-2 in FIG. 3.

At a time point t11, the signals S57, S44, and S63 become “HIGH”. Thus, the row selection MOS transistor 53 and the MOS transistor 33 in the first holding circuit unit 2 become conductive. Therefore, the voltage of the capacitor 32 is transmitted to the second column signal line 8. This voltage will be referred to as “Vrs1”. Moreover, when the MOS transistor 62 in the first difference circuit unit 3 is conducting, the Point M in FIG. 4 is “Vref”. Therefore, “Vrs1−Vref” is set in the capacitor 60.

At a time point t12, the signals S57, 545, and 592 become “HIGH”. Thus, the row selection MOS transistor 53 and the MOS transistor 36 in the first holding circuit unit 2 and a MOS transistor 81 in the second holding circuit unit 75 become conductive. Therefore, the voltage of the capacitor 35 is transmitted to the second column signal line 8. This voltage will be referred to as “Vsg1”. Since the MOS transistor 62 in the first difference circuit unit 3 is not conducting, a voltage change at the M point is defined by a voltage change in the second column signal line 8 and the capacitance ratio of the capacitor 60 to the capacitor 61. The voltage change in the second column signal line 8 is “Vrs1−Vsg1”, and the coefficient of capacitance is “C1/(C1+C2)”. Therefore, a voltage change at the Point M is “C1/(C1+C2)×(Vrs1−Vsg1)”. This voltage is transmitted through the MOS transistor 81 and stored in the capacitor 82.

At a time point t14, the signals S58, S48, and S63 become “HIGH”. Thus, the row selection MOS transistor 55 and the MOS transistor 39 in the first holding circuit unit 2 become conductive. Therefore, the voltage of the capacitor 38 is transmitted to the second column signal line 8. This voltage will be referred to as “Vrs2”. Moreover, when the MOS transistor 62 in the first difference circuit unit 3 is conducting, the Point M in FIG. 4 is called “Vref”. Therefore, “Vrs2−Vref” is set in the capacitor 60.

At a time point t15, the signals S58, S49, and S95 become “HIGH”. Thus, the row selection MOS transistor 55 and the MOS transistor 42 in the first holding circuit unit 2 and a MOS transistor 84 in the second holding circuit unit 75 become conductive. Therefore, the voltage of the capacitor 41 is transmitted to the second column signal line 8. This voltage will be referred to as “Vsg1”. Since the MOS transistor 62 of the first difference circuit unit 3 is not conducting, a voltage change at the M point is defined by a voltage change in the second column signal line 8 and the capacitance ratio of the capacitor 60 to the capacitor 61. The voltage change in the second column signal line 8 is “Vrs2−Vsg2”, and the coefficient of capacitance is “C1/(C1+C2)”. Therefore, a voltage change at the Point M is “C1/(C1+C2)×(Vrs2−Vsg2)”. This voltage is transmitted through the MOS transistor 84 and stored in the capacitor 85.

Thus, by a time point t16, differential signals “C0×(Vrs1−Vsg1)” and “C0×(Vrs2−Vsg2)” are stored in the capacitor 82 and the capacitor 85 in the second holding circuit unit 75, respectively. It should be noted that C0=C1/(C1+C2).

At a time point t17, the signals S99, S94, S100, S97, and S113 become “HIGH”. Thus, the MOS transistor 101, the row selection MOS transistor 89, the MOS transistor 102, and the row selection MOS transistor 90 in the second holding circuit unit 75 and the MOS transistor 112 in the second difference circuit unit 76 become conductive. The voltage of the reference voltage line 103 (e.g., VrefS) is transmitted to the fourth column signal line 78 through the MOS transistor 101 and the row selection MOS transistor 89 and through the MOS transistor 102 and the row selection MOS transistor 90. When both the threshold voltage of the MOS transistor 87 and the threshold voltage of the MOS transistor 88 are “Vt”, this voltage is “VrefS−Vt”. In the second difference circuit unit 76, when the MOS transistor 112 becomes conductive, the point N in FIG. 12 is “Vref1”. Therefore, “VrefS−Vt−Vref1” is set in the capacitor 110.

At a time point t18, the signals S94 and S93 become “HIGH”. Thus, the row selection MOS transistor 89 and the MOS transistor 83 become conductive. Therefore, the voltage “C0×(Vrs1−Vsg1)” held in the capacitor 82 is transmitted to the fourth column signal line 78. The voltage value “C0×(Vrs1−Vsg1)−Vt” is generated in fourth column signal line 78. Since the MOS transistor 112 in the second difference circuit unit 76 is not conducting, a voltage change at the N point is defined by a voltage change in the fourth column signal line 78 and the capacitance ratio of the capacitor 110 to the capacitor 111. The voltage change in the fourth column signal line 78 is “VrefS−C0×(Vrs1−Vsg1)”, and the coefficient of capacitance is “C11/(C11+C12)”. Therefore, the voltage change at the point N is “Vrf1-C00×(VrefS−C0×(Vrs1−Vsg1))”. It should be noted that C00=C11/(C11+C12).

At a time point t19, the signals S97 and S96 become “HIGH”. Thus, the row selection MOS transistor 90 and the MOS transistor 86 become conductive. Therefore, the voltage “C0×(Vrs2−Vsg2)” (referred to as V22) held in the capacitor 85 is transmitted to the fourth column signal line 78. The voltage value “C0×(Vrs2−Vsg2)−Vt” is generated in fourth column signal line 78.

Since the MOS transistor 112 of the second difference circuit unit 76 is not conducting, a voltage change at the N point is defined by a voltage change in the fourth column signal line 78 and the capacitance ratio of the capacitor 110 to the capacitor 111. The voltage change in the fourth column signal line 78 is “Vrf1-C00×(VrefS−C0×(Vrs1−Vsg1)−C00×(C0×(Vrs2−Vsg2)−Vt)”, and the coefficient of capacitance is “C00”. Therefore, the voltage change at the point N is “C00×((Vrf1−C00×(VrefS−C0×(Vrs1−Vsg1)−C00×(C0×(Vrs2−Vsg2)−Vt))”. Thus, the second holding circuit unit 75 holds differential signals between electrical signals in the reset state and electrical signals in the light received state in the pixel circuit unit 1. Therefore, signals of two rows can be combined at the second difference circuit unit 76. Thus, it is possible to combine pixel signals more accurately.

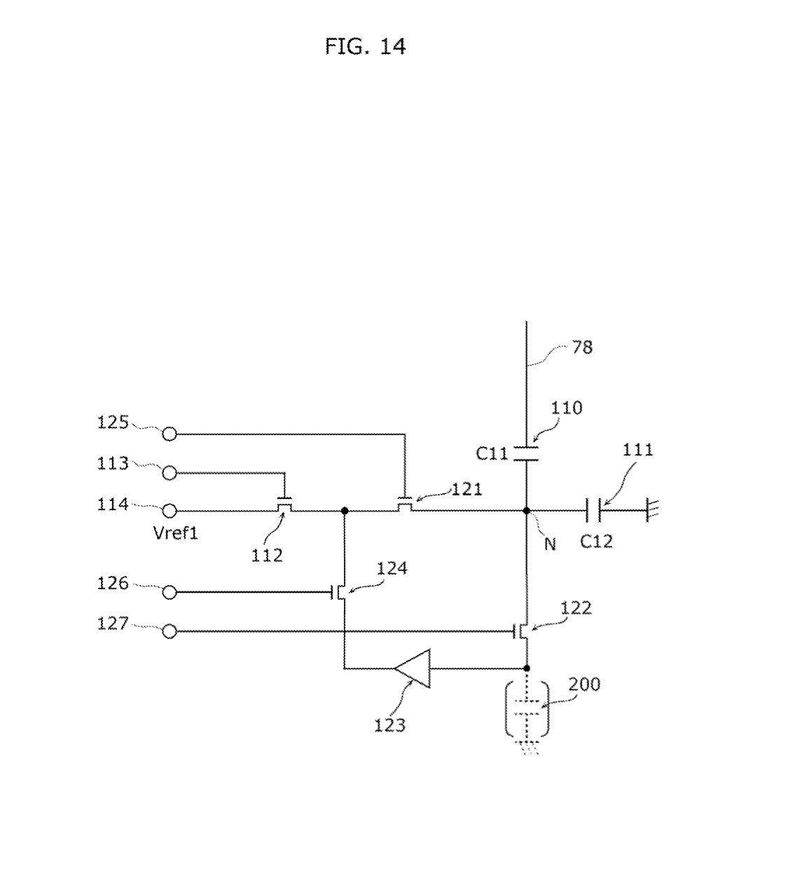

FIG. 14 is a circuit diagram shoving another configuration example of the second difference circuit unit 76. It should be noted that FIG. 14 shows a detailed configuration of one column of the first difference circuits 76 provided for one of the second holding circuit units 75.

The second difference circuit unit 76 is connected to the fourth column signal line 78 to which output from the second holding circuit unit 75 is transmitted, and includes the capacitor 110 having the capacitance value C11, the capacitor 111 having the capacitance value C12, and the MOS transistor 112. One terminal of the capacitor 110 is connected to the fourth column signal line 78, and the other terminal is connected to the source of a MOS transistor 121 and the connection node of one terminal of the capacitor 111 (the point N in FIG. 14). One terminal of the capacitor 111 is connected to the point N, and the other terminal is earthed. The source of the MOS transistor 112 is connected to the drain of the MOS transistor 121. The drain of the MOS transistor 112 is connected to a terminal 114. The gate of the MOS transistor 112 is connected to the terminal 113. A bias voltage is applied to the terminal 114.

Moreover, the second difference circuit unit 76 includes the MOS transistors 121, 122, and 124 and a buffer 123. The drain of the MOS transistor 121 is connected to the sources of MOS transistors 112 and 124. The source of the MOS transistor 121 is connected to the point N. The gate of the MOS transistor 121 is connected to a terminal 125. The drain of the MOS transistor 122 is connected to the point N. The source of the MOS transistor 122 is connected to input of the buffer 123. The gate of the MOS transistor 122 is connected to a terminal 127. The drain of the MOS transistor 124 is connected to the output of the buffer 123. The gate of the MOS transistor 124 is connected to a terminal 126.

The following describes the operations of a solid-state imaging device according to the present embodiment, with reference to FIGS. 3, 4, 11 and 15.

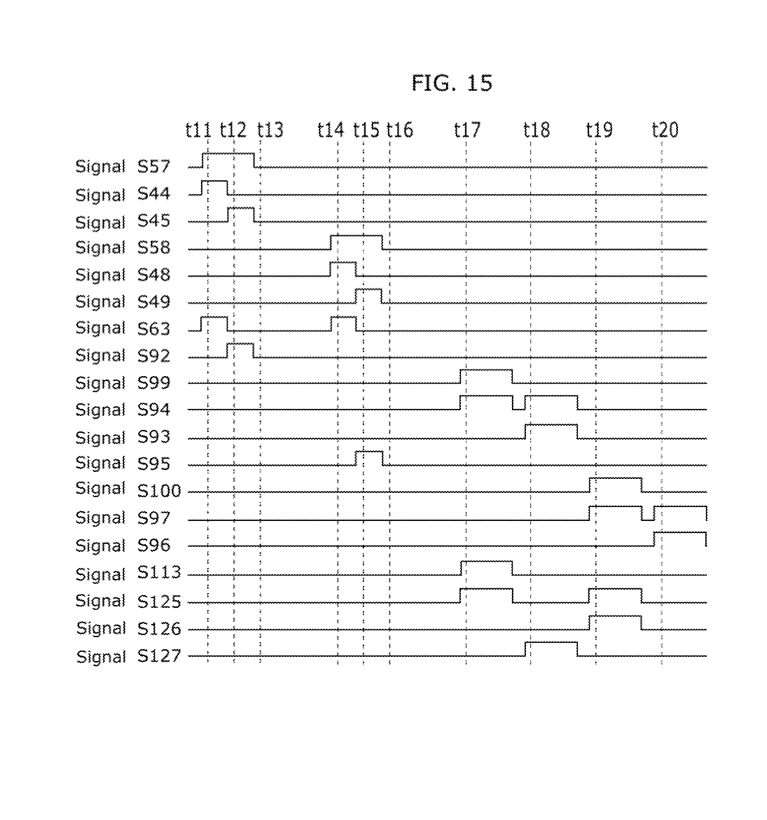

FIG. 15 is a timing chart showing major changes in signals along with time change in pixel combining operations of the solid-state imaging device according to the present embodiment. FIG. 15 shows control signals applied to the terminals of the first holding circuit unit 2 in FIG. 3, the first difference circuit unit 3 in FIG. 4, the second holding circuit unit 75 in FIG. 11, and the second difference circuit unit 76 in FIG. 14.

It should be noted that in FIG. 15, each control signal is named in such a way that “S” is given before the reference numeral of a terminal to which a signal is applied. Therefore, the signal S57 is applied to the terminal 57 and inputted to the gate of the row selection MOS transistor 53. The signal S44 is applied to the terminal 44 and inputted to the gate of the MOS transistor 33. The signal S45 is applied to the terminal 45 and inputted to the gate of the MOS transistor 36. The signal S58 is applied to the terminal 58 and inputted to the gate of the row selection MOS transistor 55. The signal S48 is applied to the terminal 48 and inputted to the gate of the MOS transistor 39. The signal S49 is applied to the terminal 49 and inputted to the gate of the MOS transistor 42. The signal S63 is applied to the terminal 63 and inputted to the gate of the MOS transistor 62. The signal S92 is applied to the terminal 92 and inputted to the gate of the MOS transistor 81. The signal S99 is applied to the terminal 99 and inputted to the gate of the MOS transistor 101. The signal S94 is applied to the terminal 94 and inputted to the gate of the row selection MOS transistor 89. The signal S93 is applied to the terminal 93 and inputted to the gate of the MOS transistor 83. The signal S95 is applied to the terminal 95 and inputted to the gate of the MOS transistor 84. The signal S100 is applied to the terminal 100 and inputted to the gate of the MOS transistor 102. The signal S97 is applied to the terminal 97 and inputted to the gate of the row selection MOS transistor 90. The signal S96 is applied to the terminal 96 and inputted to the gate of the MOS transistor 86. The signal S113 is applied to the terminal 113 and inputted to the gate of the MOS transistor 112. A signal S125 is applied to the terminal 125 and inputted to the gate of the MOS transistor 121. The signal S126 is applied to the terminal 126 and inputted to the gate of the MOS transistor 124. A signal S127 is applied to the terminal 127 and inputted to the gate of the MOS transistor 122.

In FIG. 15 and FIG. 13, the operations from the time points t1 to t16 are the same. Therefore, the explanation will be omitted below. By the time point t16, differential signals “C0×(Vrs1−Vsg1)” and “C0×(Vrs2−Vsg2)” are stored in the capacitor 82 and the capacitor 85 in the second holding circuit unit 75, respectively. It should be noted that C0=C1/(C1++C2).

At the time point t17, the signals S99, 594, 5113, and 5125 become “HIGH”. Thus, the MOS transistor 101 and the row selection MOS transistor 89 in the second holding circuit unit 75 and the MOS transistors 112 and 121 in the second difference circuit unit 76 become conductive. The voltage (VrefS) of the reference voltage line 103 is transmitted to the fourth column signal line 78 through the MOS transistor 101 and the row selection MOS transistor 89. When the threshold value of the MOS transistors 87 is “Vt87”, this voltage is “VrefS−Vt87”. In the second difference circuit unit 76, when the MOS transistors 112 and 121 become conductive, the point N in FIG. 14 is “Vref1”. Therefore, “VrefS−Vt87−Vref1” is set in the capacitor 110.

At the time point t18, the signals S94, S93 and S127 become “HIGH”. Thus, the row selection MOS transistor 89 and the MOS transistor 83 become conductive. Therefore, the voltage “C0×(Vrs1−Vsg1)” held in the capacitor 82 is transmitted to the fourth column signal line 78. The voltage “C0×(Vrs1−Vsg1)−Vt87” is transmitted to the fourth column signal line 78. Since the MOS transistor 112 of the second difference circuit unit 76 is not conducting, a voltage change at the N point is defined by a voltage change in the fourth column signal line 78 and the capacitance ratio of the capacitor 110 to the capacitor 111. The voltage change in the fourth column signal line 78 is “VrefS−C0×(Vrs1−Vsg1)”, and the coefficient of capacitance is “C11/(C11+C12)” (referred to as C00). Therefore, the voltage change at the point N is “Vref1−C00×(VrefS−C0×(Vrs1−Vsg1))”. After transmitting through the MOS transistor 122, this voltage is stored in stray capacitance (the capacitance 200 shown in a parenthesis in FIG. 14) and inputted to the input of the buffer 123.

At the time point t19, the signals S100, S97, S125, and S126 become “HIGH”. Thus, the row selection MOS transistor 90 and the MOS transistor 102 become conductive. Therefore, the voltage (VrefS) of the reference voltage line 103 is transmitted to the forth column signal line 78 through the MOS transistor 102 and the row selection MOS transistor 90. When the threshold value of the MOS transistors 88 is “Vt88”, this voltage is “VrefS−Vt88”. In the second difference circuit unit 76, the MOS transistor 112 is not conducting while the MOS transistor 124 is conducting. Therefore, the voltage change at the point N is set to the output of the buffer 123 “Vref1−C00×(VrefS−C0×(Vrs1−Vsg1))”. At this point, the voltage on the side of the fourth column signal line 78 of the capacitor 110 is “VrefS−Vt88”.

At a time point t20, the signals S97 and 596 become “HIGH”. Thus, the row selection MOS transistor 90 and the MOS transistor 86 become conductive. Therefore, the voltage “C0×(Vrs2−Vsg2)” held in the capacitor 85 is transmitted to the fourth column signal line 78. When the threshold value of the MOS transistor 88 is Vt88, the voltage “C0×(Vrs2−Vsg2)−Vt88” is transmitted to the fourth column signal line 78. Since the MOS transistor 112 of the second difference circuit unit 76 is not conducting, a voltage change at the N point is defined by a voltage change in the fourth column signal line 78 and the capacitance ratio of the capacitor 110 to the capacitor 111. The voltage change in the fourth column signal line 78 is “VrefS−C0×(Vrs2−Vsg2)”, and the coefficient of capacitance is “C11/(C11+C12)” (referred to as COO). Therefore, the voltage change at the point N is “Vref1−C00×(VrefS−C0×(Vrs1−Vsg1))−C00×(VrefS−C0×(Vrs2−Vsg2))”. Thus, “Vref1−C00×(2VrefS−C0×(Vrs1+Vrs2−Vsg1−Vsg2))” is obtained.

Thus, the second holding circuit unit 75 holds differential signals between electrical signals in the reset state and electrical signals in the light received state in the pixel circuit unit 1. Therefore, signals of two rows can be combined at the second difference circuit unit 76. Thus, it is possible to combine pixel signals more accurately.

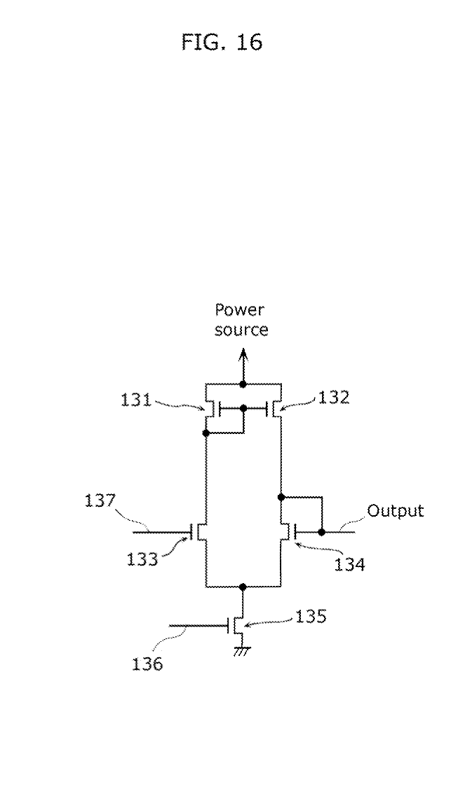

FIG. 16 is a circuit diagram showing a configuration of the buffer 123.

The buffer 123 includes MOS transistors 131, 132, 133, 134, and 135. The drain of the MOS transistor 131 is connected to a power supply. The gate of the MOS transistor 131 is connected to the source of the MOS transistor 131 and the drain of the MOS transistor 133. The drain of the MOS transistor 132 is connected to the power supply. The gate of the MOS transistor 132 is connected to the gate of the MOS transistor 131. The source of the MOS transistor 132 is connected to the drain of the MOS transistor 134. The sources of the MOS transistor 133 and the MOS transistor 134 are interconnected. A gate 137 of the MOS transistor 133 is connected to input. The gate of the MOS transistor 134 is connected to the drain of the MOS transistor 134 itself and servers as output. The drain of the MOS transistor 135 is connected to the sources of the MOS transistors 133 and 134. The source of the MOS transistor 135 is earthed. A bias voltage is applied to a gate 136.

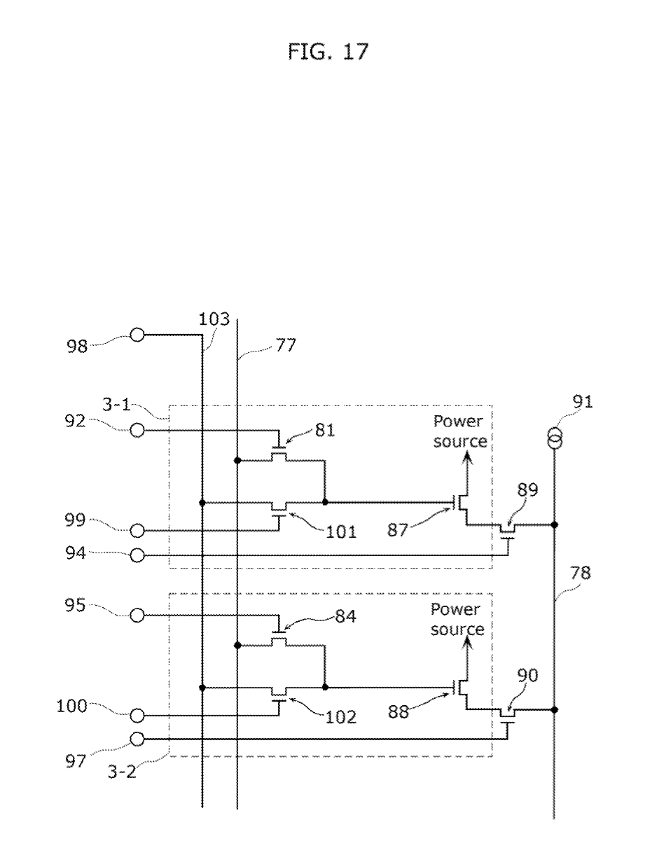

FIG. 17 is a circuit diagram showing another configuration of the second holding circuit unit 75. It should be noted that FIG. 17 shows the detail of one column and two rows of the second holding circuit units 75. More specifically, FIG. 17 shows the detail of pixel-wise holding circuits 3-1 and 3-2 that are provided for one of the first difference circuit unit 3 and are indicated by broken lines in FIG. 17.

The pixel-wise holding circuit 3-1 includes the MOS transistors 81, 87, and 101. The drain of the MOS transistor 81 is connected to the third column signal line 77. The source of the MOS transistor 81 is connected to the gate of the MOS transistor 87. The gate of the MOS transistor 81 is connected to the terminal 92. The drain of the MOS transistor 101 is connected to a reference voltage line 103. The gate of the MOS transistor 101 is connected to a terminal 99. The source of the MOS transistor 101 is connected to the gate of the MOS transistor 87. The drain of the MOS transistor 87 is connected to a power supply. The source of the MOS transistor 87 is connected to the drain of a row selection MOS transistor 89. The gate of the row selection MOS transistor 89 is connected to a terminal 94. The source of the row selection MOS transistor 89 is connected to the fourth column signal line 78.

The pixel-wise holding circuit 3-2 includes the MOS transistors 84, 88, and 102. The drain of the MOS transistor 84 is connected to the third column signal line 77. The source of the MOS transistor 84 is connected to the gate of the MOS transistor 88. The gate of the MOS transistor 84 is connected to the terminal 95. The drain of the MOS transistor 102 is connected to the reference voltage line 103. The gate of the MOS transistor 102 is connected to a terminal 100. The source of the MOS transistor 102 is connected to the gate of the MOS transistor 88. The drain of the MOS transistor 88 is connected to a power supply. The source of the MOS transistor 88 is connected to the drain of a row selection MOS transistor 90. The gate of the row selection MOS transistor 90 is connected to a terminal 97. The source of the row selection MOS transistor 90 is connected to the fourth column signal line 78. A current source 91 and the MOS transistor 87 form a source follower when the corresponding row selection MOS transistor 89 is conducting. The current source 91 and the MOS transistor 88 form a source follower when the corresponding row selection MOS transistor 90 is conducting. The reference voltage line 103 is connected to the terminal 98.

The following describes the operations of a solid-state imaging device according to the present embodiment, with reference to FIGS. 3, 4, 17, and 12.

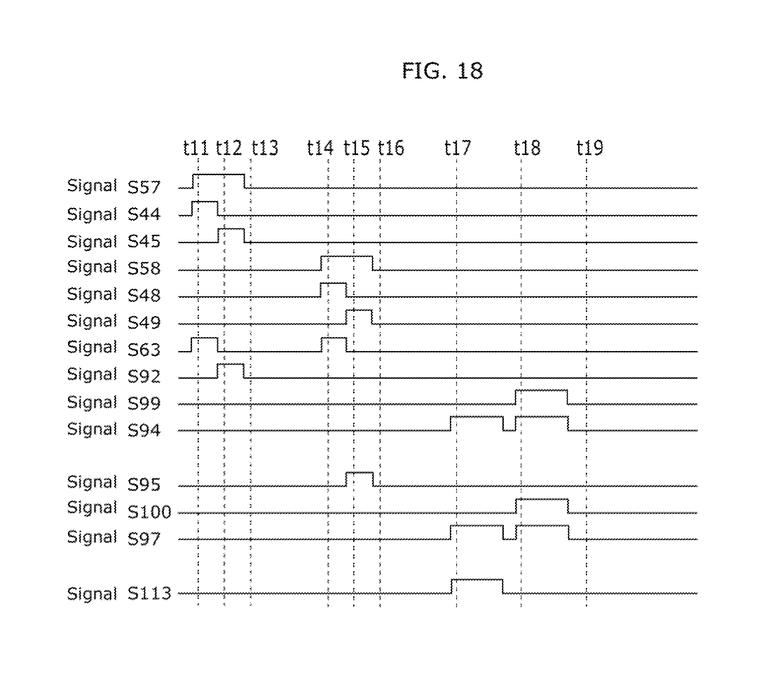

FIG. 18 is a timing chart showing major changes in signals along with time change in pixel combining operations of the solid-state imaging device according to the present embodiment. FIG. 18 shows control signals applied to the terminals of the first holding circuit unit 2 in FIG. 3, the first difference circuit unit 3 in FIG. 4, the second holding circuit unit 75 in FIG. 17, and the second difference circuit unit 76 in FIG. 12.

It should be noted that in FIG. 18, each control signal is named in such a way that “S” is given before the reference numeral of a terminal to which a signal is applied. Therefore, the signal S57 is applied to the terminal 57 and inputted to the gate of the row selection MOS transistor 53. The signal S44 is applied to the terminal 44 and inputted to the gate of the MOS transistor 33. The signal S45 is applied to the terminal 45 and inputted to the gate of the MOS transistor 36. The signal S58 is applied to the terminal 58 and inputted to the gate of the row selection MOS transistor 55. The signal S48 is applied to the terminal 48 and inputted to the gate of the MOS transistor 39. The signal S49 is applied to the terminal 49 and inputted to the gate of the MOS transistor 42. The signal S63 is applied to the terminal 63 and inputted to the gate of the MOS transistor 62. The signal S92 is applied to the terminal 92 and inputted to the gate of the MOS transistor 81. The signal S99 is applied to the terminal 99 and inputted to the gate of the MOS transistor 101. The signal S94 is applied to the terminal 94 and inputted to the gate of the row selection MOS transistor 89. The signal S95 is applied to the terminal 95 and inputted to the gate of the MOS transistor 84. The signal S100 is applied to the terminal 100 and inputted to the gate of the MOS transistor 102. The signal S97 is applied to the terminal 97 and inputted to the gate of the row selection MOS transistor 90. The signal S113 is applied to the terminal 113 and inputted to the gate of the MOS transistor 112.

In FIG. 17 and FIG. 6, the operations from the time points t1 to t16 are the same. Therefore, the explanation will be omitted below. By the time point t10, electrical signals in the reset state from the pixel circuit unit 1 are stored in the capacitor 32 of the pixel-wise holding circuit 2-1 and in the capacitor 38 of the pixel-wise holding circuit 2-2 in FIG. 3, and electrical signals in the light-received state are stored in the capacitor 35 of the pixel-wise holding circuit 2-1 and in the capacitor 41 of the pixel-wise holding circuit 2-2 in FIG. 3.

At the time point t11, the signals S57, 544, and S63 become “HIGH”. Thus, the row selection MOS transistor 53 and the MOS transistor 33 in the first holding circuit unit 2 become conductive. Therefore, the voltage of the capacitor 32 is transmitted to the second column signal line 8. This voltage will be referred to as “Vrs1”. Moreover, when the MOS transistor 62 in the first difference circuit unit 3 is conducting, the Point M in FIG. 4 is “Vref”. Therefore, “Vrs1−Vfer” is set in the capacitor 60.

At the time point t12, the signals S57, S45, and S92 become “HIGH”. Thus, the row selection MOS transistor 53 and the MOS transistor 36 in the first holding circuit unit 2 and the MOS transistor 81 in the second holding circuit unit 75 become conductive. Therefore, the voltage of the capacitor 35 is transmitted to the second column signal line 8. This voltage will be referred to as “Vsg1”. Since the MOS transistor 62 in the first difference circuit unit 3 is not conducting, a voltage change at the M point is defined by a voltage change in the second column signal line 8 and the capacitance ratio of the capacitor 60 to the capacitor 61. The voltage change in the second column signal line 8 is “Vrs1−Vsg1”, and the coefficient of capacitance is “C1/(C1+C2)”. Therefore, the voltage change at the Point M is “C1/(C1+C2)×(Vrs1−Vsg1)”. This voltage is transmitted through the MOS transistor 81 and stored in the gate of the MOS transistor 87.

At the time point t14, the signals S58, 548, and S63 become “HIGH”. Thus, the row selection MOS transistor 55 and the MOS transistor 39 in the first holding circuit unit 2 become conductive. Therefore, the voltage of the capacitor 38 is transmitted to the second column signal line 8. This voltage will be referred to as “Vrs2”. Moreover, when the MOS transistor 62 in the first difference circuit unit 3 is conducting, the Point M in FIG. 4 is “Vref”. Therefore, “Vrs2−Vref” is set in the capacitor 60.

At the time point t15, the signals S58, 549, and S95 become “HIGH”. Thus, the row selection MOS transistor 55 and the MOS transistor 42 in the first holding circuit unit 2 and the MOS transistor 84 in the second holding circuit unit 75 become conductive. Therefore, the voltage of the capacitor 41 is transmitted to the second column signal line 8. This voltage will be referred to as “Vsg2”. Since the MOS transistor 62 of the first difference circuit unit 3 is not conducting, a voltage change at the M point is defined by a voltage change in the second column signal line 8 and the capacitance ratio of the capacitor 60 to the capacitor 61. The voltage change in the second column signal line 8 is “Vrs2−Vsg2”, and the coefficient of capacitance is “C1/(C1+C2)”. Therefore, the voltage change at the point M is “C1/(C2+C2)×(Vrs2−Vsg2)”. This voltage is transmitted through the MOS transistor 84 and stored in the gate of the MOS transistor 88. In other words, by the time point t16, the differential signals “C0×(Vrs1−Vsg1)” and “C0×(Vrs2−Vsg2)” are stored in the gate of the MOS transistor 87 and the gate of the MOS transistor 88 in the second holding circuit unit 75, respectively. It should be noted that C0=C1/(C1+C2).

At the time point t17, the signals S94, S97, and S113 become “HIGH”. Thus, the row selection MOS transistors 89 and 90 in the second holding circuit unit 75 and the MOS transistor 112 in the second difference circuit unit 76 become conductive. The differential signal “C0×(Vrs1−Vsg1)−Vt (Vt is the threshold value of the MOS transistor 87)” held in the gate of the MOS transistor 87 is transmitted to the fourth column signal line 78 through the row selection MOS transistor 89. The differential signal “C0×(Vrs2−Vsg2−Vt (Vt is the threshold value of the MOS transistor 88)” held in the gate of the MOS transistor 88 is transmitted to the fourth column signal line 78 through the row selection MOS transistor 90. When two rows of pixel-wise holding circuits (two pixel-wise holding circuits) are selected at the same time, signals are combined as described in the first embodiment. The combined signal value generated in the fourth column signal line 78 is “VC”. In the second difference circuit unit 76, when the MOS transistor 112 becomes conductive, the point N in FIG. 12 is called “Vref1”. Therefore, “VC−Vref1” is set in the capacitor 110.

At the time point t18, the signals S99, S94, S100, and S97 become “HIGH”. Thus, the MOS transistors 101 and 102 and the row selection MOS transistors 89 and 90 become conductive. Therefore, the voltage (Vref) of the reference voltage line 103 is transmitted to the fourth column signal line 78 through the MOS transistors 101 and 87 and the row selection MOS transistor 89 and through the MOS transistors 102 and 88 and the row selection MOS transistor 90. This voltage value is Vref−Vt. After that, as mentioned above, the difference between these two signals is derived at the second difference circuit unit 76 (an explanation for difference deriving operations is omitted here).

As mentioned above, when signals are held by the gate of a MOS transistor instead of employing a holding circuit using a capacitor, similar operations are possible.

As mentioned above, a solid-state imaging device of the present embodiment can achieve high-speed signal processing while reducing video distortion. Moreover, noise can be reduced.

### Embodiment 4

The fourth embodiment of the present invention will be described.

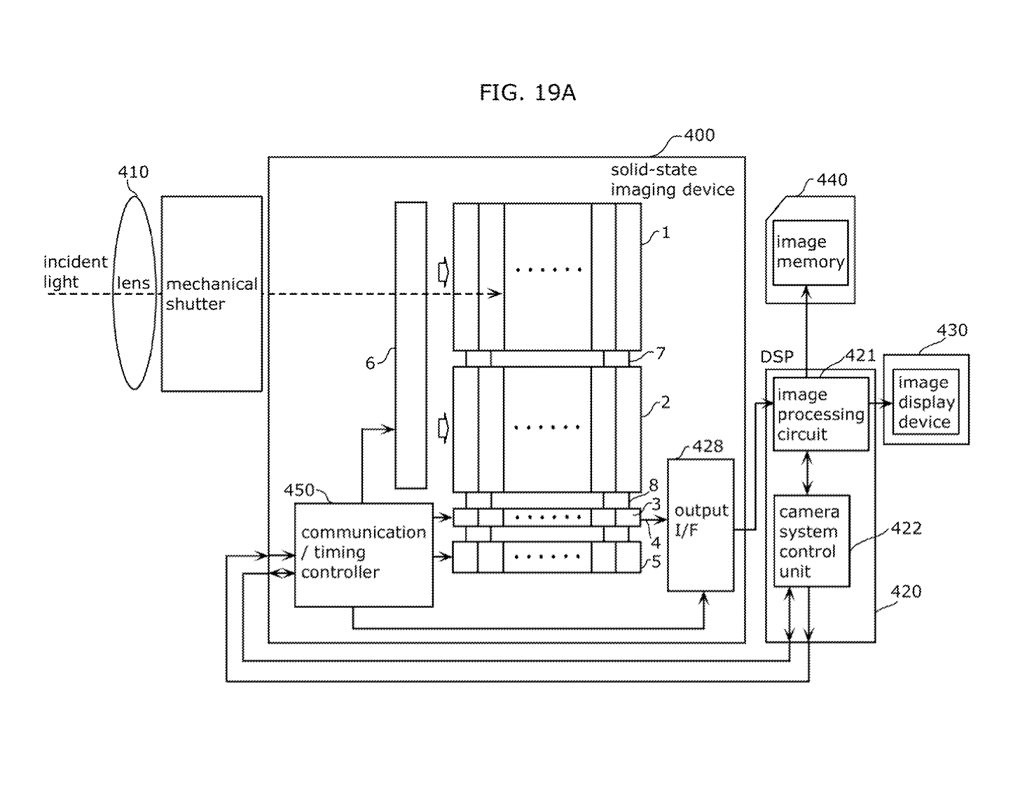

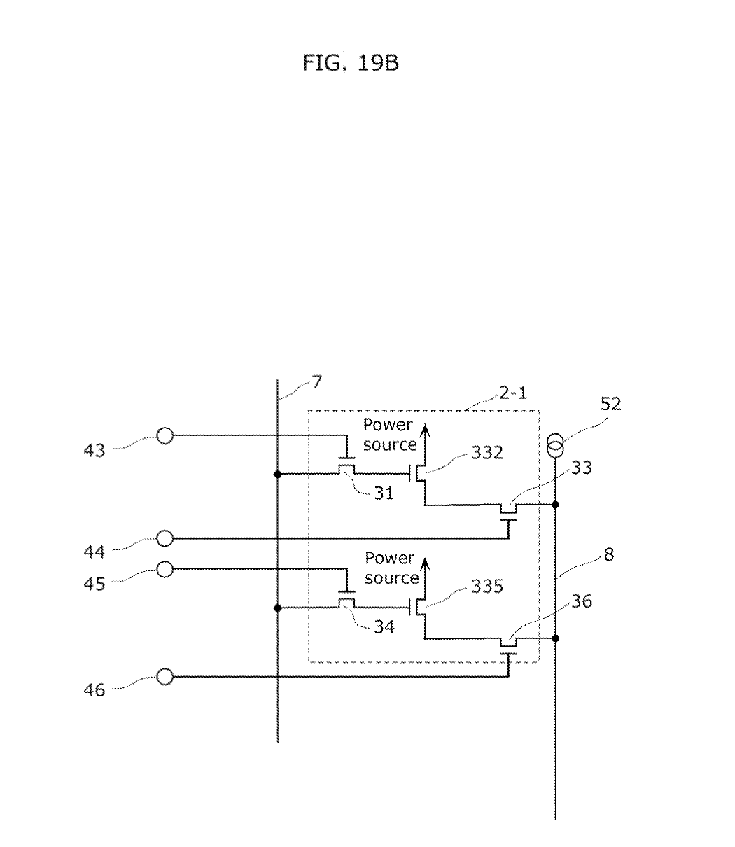

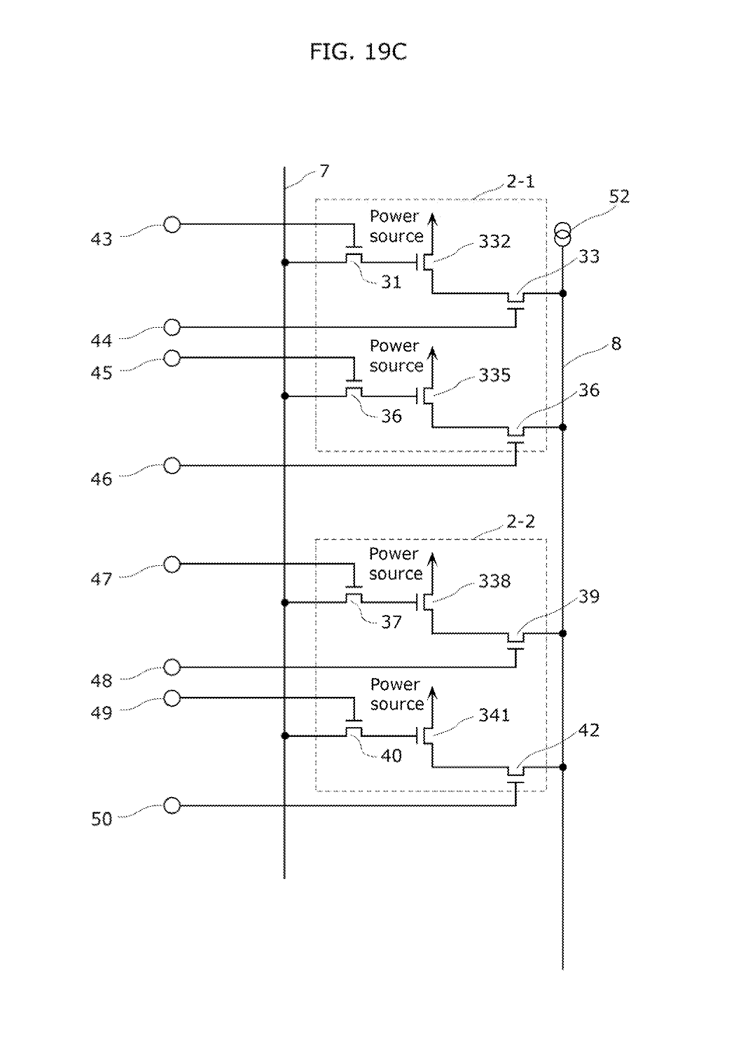

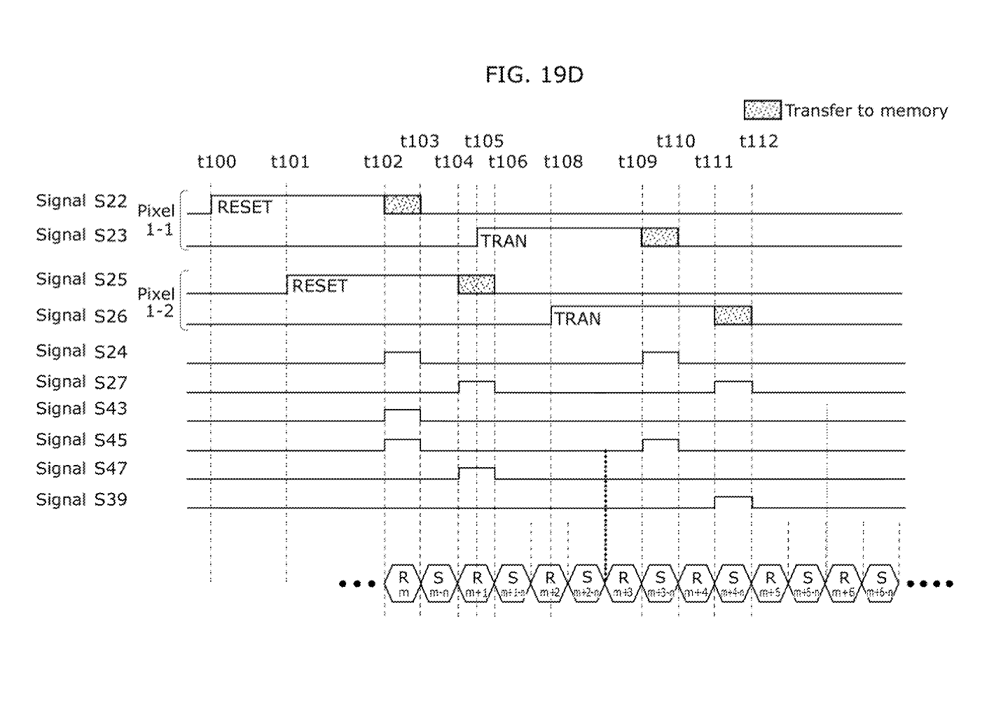

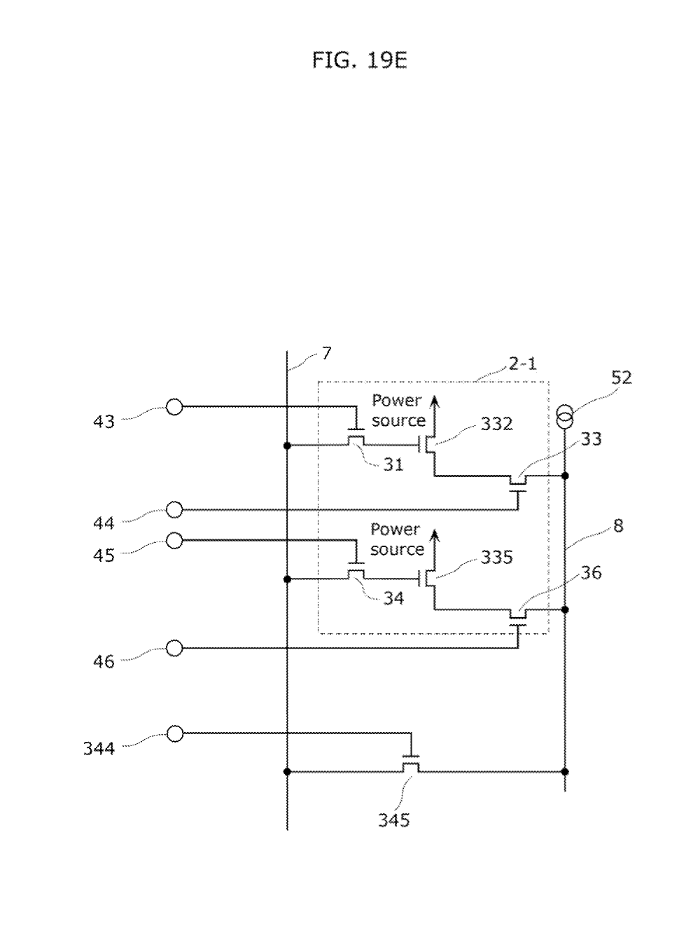

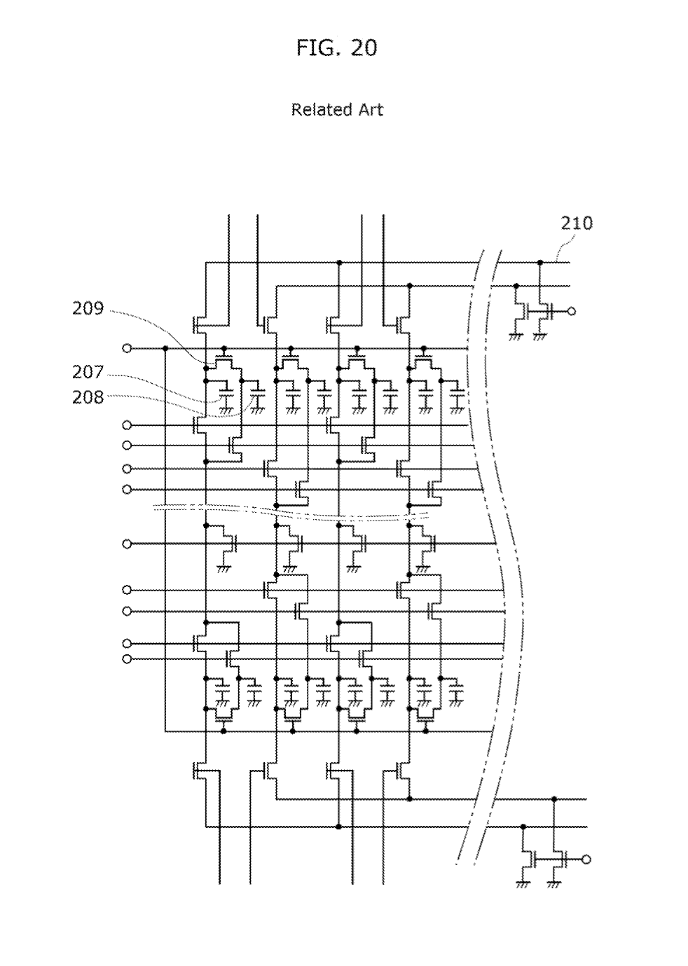

FIG. 19A shows an outline of the configuration of a camera according to the present embodiment. It should be noted that arrow signs in FIG. 19A are directions in which various signals are transmitted.

The camera in FIG. 19A includes a solid-state imaging device 400, a lens 410, a mechanical shutter, a digital signal processing circuit (DSP) 420, an image display device 430, and an image memory 440. It should be noted that a lens shutter or a focal-plane shutter is used for the mechanical shutter. Moreover, the focal-plane shutter includes two curtains, that is, a front curtain and a rear curtain. Moreover, straight arrow signs in FIG. 19A indicate directions in which various signals are transmitted.

In this camera, light is incident from the outside through the lens 410, the incident light is converted into an output signal by the solid-state imaging device 400, and the output signal is outputted from an output line 4 and an output I/F428. The outputted output signal is processed by the DSP 420. As a video signal, the processed signal is outputted to and stored in the image memory 440, and is outputted to and displayed at the image display device 430.

The DSP 420 includes an image processing circuit 421 and a camera system control unit 422. The image processing circuit 421 performs processing such as noise reduction for output signals of the solid-state imaging device 400 to generate video signals. The camera system control unit 422 controls scan timing and gain for pixels in the solid-state imaging device 400. The DSP 420, for example, compensates a characteristic difference between pixels shared in pixels in the solid-state imaging device 400.

A communication/timing controller (timing generator) 450 (1) receives master clock CLK0 and data DATA that are inputted through an external terminal, (2) generates various internal clocks, and (3) controls the column selection circuits 5, the row selection circuit 6, the first difference circuit units 3, and the output I/F428.

It should be noted that in the present embodiment, an analog/digital signal processor (AD converter) may be provided between the first holding circuit units 2 and the output I/F428.

Although a solid-state imaging device and a camera according to the present invention are described above based on the embodiments, the present invention is not limited to these embodiments. The present invention includes various modifications which a person skilled in the art would conceive without materially departing from the novel teachings and advantages of the present invention. Moreover, structural elements in embodiments may be optionally combined within the scope of the present invention.

For example, in the above embodiments, electrical signals read from the pixels are held by capacitors in the first holding circuit units 2. However, as shown in FIG. 198, transistors 332 and 335 may be provided instead of the capacitors 32 and 35 in the first holding circuit unit 2 shown in FIG. 3. By connecting the first column signal line 7 to the gates of the transistors 332 and 335, electrical signals read from pixels may be held by the gates. In this case, even if signals held by the first holding circuit unit 2 are read, signals (electric charges) in the gates of the transistors 332 and 335 remain and are not lost. Therefore, it is possible to realize nondestructive readout that allows repeated readouts. For example, when a rectangular area is read in the above random access, the rectangular area, the position of which is slightly shifted can be, for example, read again.

In this case, various operations can be performed. The following describes (1) a mechanical shutter mode combined with the above mentioned mode (hereinafter referred to as a combination mode using a mechanical shutter), (2) a memory through mode, and (3) a several-frame holding mode.

(1) The combination mode using a mechanical shutter will be described below. FIG. 19C shows a configuration of the first holding circuit unit 2 having two rows of pixel-wise holding circuits 2-1 and 2-2. FIG. 19C shows one column and two rows of pixel-wise holding circuits. In this configuration, the holding transistors 332 and 335 are provided instead of the capacitors 32 and 35 in the pixel-wise holding circuit 2-1 shown in FIG. 3. In addition, holding transistors 338 and 341 are provided instead of the capacitors 38 and 41 in the pixel-wise holding circuit 2-2 shown in FIG. 3. The pixel-wise holding circuits 2-1 and 2-2 are connected to the first column signal line 7 and the second column signal line 8. The holding transistor 332 forms a source follower together with the MOS transistor 33 and a current source 52. Moreover, the holding transistor 335 forms a source follower together with the MOS transistor 36 and the current source 52. Moreover, the holding transistor 338 forms a source follower together with the MOS transistor 39 and the current source 52. Moreover, the holding transistor 341 forms a source follower together with the MOS transistor 42 and the current source 52. The pixel-wise holding circuits 2-1 and 2-2 hold the signal output that is inputted from the first column signal line 7, in the gate capacitance of the holding transistors 332, 335, 338, and 341, and output the signal output to the second column signal line 8. Therefore, the pixel-wise holding circuits 2-1 and 2-2 serve as both holding capacitance and amplifiers (transistors for amplification).

FIG. 19D is a timing chart showing major changes in signals along with time change in a solid-state imaging device having the configuration of FIG. 19C.

FIG. 190 shows control signals which are applied from the row selection circuit 6 to the terminals 22, 23, 24, 25, 26, 27, 43, 45, 47, and 49 shown in FIGS. 2 and 19C. It should be noted that each control signal is named in such a way that “S” is given before the reference numeral of a terminal to which a signal is applied.

In operations shown in FIG. 19D, between the pixels of different rows, durations of signals for resetting pixels are partially overlapped, and durations of signals for transferring electric charges to FD are partially overlapped.

From time points t100 to t103, the signal S22 for resetting the pixel 1-1 is “HIGH”. During time points t102 and t103, the reset signal from the pixel 1-1 is transmitted through the row selection MOS transistor 14 and the MOS transistor 31 and held by the gate of the holding transistor 332. From time points t101 to t106, the signal S25 for resetting the pixel 1-2 is “HIGH”. During time points t104 and t106, the reset signal from the pixel 1-2 is transmitted through the row selection MOS transistor 19 and the MOS transistor 37 and held by the gate of the holding transistor 338. Moreover, from time points t105 to t110, the signal S23 for transferring electric charges in the pixel 1-1 to FD is “HIGH”. During time points t109 and t100, the signal of FD in the pixel 1-1 is transmitted through the row selection MOS transistor 14 and the MOS transistor 36 and held by the gate of the holding transistor 335. From time points t108 to t112, the signal S26 for transferring electric charges in the pixel 1-2 to FD is “HIGH”. During time points t111 and t112, the signal in FD in the pixel 1-2 is transmitted through the row selection MOS transistor 19 and the MOS transistor 40 and held by the gate of the holding transistor 341. When, between the pixels of different rows, signals for resetting each pixel have a partially overlapped duration and signals for transferring electric charges to the FD of each pixel have a partially overlapped duration, pixel signals can be transferred to the first holding circuit unit 2 at a high speed.

For example, when 4000 rows of pixels are selected, and one row of reset signals and signals of FD are transferred per microsecond, it takes four milliseconds to transfer pixel signals of all rows to the first holding circuit units 2.

In the case of a camera, pixel signals are transferred to the first holding circuit units 2 in four milliseconds from the moment a mechanical shutter closes. If a mode is changed to “a memory through mode” while the first holding circuit units 2 are holding pixel signals of one frame (e.g., all pixels), a monitor image (e.g., reduced image obtained by thinned-out or combination) can be obtained four milliseconds after the mechanical shutter closes. For example, when the mechanical shutter is a rear curtain shutter; this can be achieved by controls such as synchronization of the start of exposure to light by an electronic shutter and the end of exposure to light by the rear curtain shutter.

In other words, generally, a monitor image can be obtained only after one frame is processed, after shutter operation is finished by the rear curtain, i.e., after the rear curtain closes. On the other hand, in the combination mode using a mechanical shutter; a monitor image can be obtained at a high speed. Therefore, real time of the monitor image can be improved.

The following describes (2) the memory through mode. In the configuration of FIG. 19C, after the end of output of signals held by the pixel-wise holding circuits 2-1 and 2-2, the MOS transistors 31 and 33 in the pixel-wise holding circuit 2-1 that is an example of one row of the first holding circuit units 2 are caused to be always conductive. By doing so, while pixel signal information of the Nth frame before the conducting state is being held by the first holding circuit unit 2, pixel signal information of the (N+1)th frame can be outputted without being held by the first holding circuit unit 2. In other words, while pixel signal information is being held by the first holding circuit unit 2, the next pixel signal information can be read. The mode for performing such an operation is called “memory through mode”.

For such a “memory through mode”, the configuration in FIG. 19B can be changed to the configuration in FIG. 19E. In other words, as shown in FIG. 19E, the MOS transistor 345 is connected (provided) between the first column signal line 7 and the second column signal line 8. In order to cause the MOS transistor 345 to be conductive, a “HIGH” signal for causing a terminal 345 to be conductive is applied to the terminal 344 to which the gate of the MOS transistor 345 is connected. This also enables the above operation. Depending on the demand characteristics and capturing mode of a camera, degraded image quality due to noise and dark current that are caused by holding signals in the first holding circuit unit 2 may be problems. In such a case, to realize low noise and low dark current, “the memory through mode” is used so that while pixel signal information is being held by the first holding circuit unit 2, next pixel signal information is read.

The following describes (3) the several-frame holding mode. In the above embodiments, the first holding circuit unit 2 has pixel-wise holding circuits of the number same as the pixels of one column of the pixel circuit unit 1. However, it is possible to provide pixel-wise holding circuits, the number of which is greater than the number of pixels of one column.

For instance, when the number of pixel-wise holding circuits is increased to twice the number of pixels of one column, pixel signal information of two frames can be held by the first holding circuit unit 2. Therefore, for example, one frame of pixel signal information in a dark condition and one frame of pixel signal information in a bright condition are caused to be held by the first holding circuit unit 2 in order to obtain the difference between the pixel signal information in the dark condition and the pixel signal information in the bright condition. Shading of the pixel circuit unit 1 can be corrected. Providing pixel-wise holding circuits, the number of which is greater than the number of pixels of one column can correct or process pixel signal information.

Moreover, even when pixel-wise holding circuits of the number same as the pixels in the pixel circuit unit 1 are provided, it is possible to cause the first holding circuit units 2 to hold several frames of fewer number of pixels by decimating pixels. For example, by horizontally and vertically decimating one pixel of two adjacent pixels, four frames of pixels, the number of which is ¼ the number of original pixels can be held in the first holding circuit units 2. For example, by horizontally and vertically decimating one of three adjacent pixels, nine frames of pixels, the number of which is 1/9 the number of original pixels can be held by the first holding circuit units 2. For example, if temporally consecutive frames having different exposure durations are held by the first holding circuit unit 2, and several frames are incorporated into one frame by an external device of the solid-stating imaging device, an image with improved dynamic range can be obtained.

It should be noted that a solid-state imaging device may perform operations by combining the operation modes (1) to (3). This facilitates high-speed operations because the solid-state imaging device can, using internal operation modes, perform operations which were conventionally performed only outside the device.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is useful for solid-state imaging devices, and is particularly useful for, for example, digital still cameras having a video capturing function.

1. A solid-state imaging device comprising:
pixels arrayed two-dimensionally, each of which outputs an electrical signal in a reset state and an electrical signal in a light-received state;
column signal lines each of which corresponds to one of columns of the pixels and transmits an electrical signal in the reset state and an electrical signal in the light-received state, from the corresponding column of the pixels;
first holding circuit units each of which corresponds to one of the column signal lines, and holds electrical signals in the reset state and electrical signals in the light-received state that are transmitted from the pixels through the corresponding one of the column signal lines; and
first difference circuit units each configured to output a difference between one of the electrical signals in the reset state and one of the electrical signals in the light-received state that are held by one of the first holding circuit units,
wherein the first holding circuit units each include pixel-wise holding circuits, the number of which is identical to the number of the pixels provided for the corresponding one of the column signal lines, the pixel-wise holding circuits being able to hold electrical signals in the reset state of the pixels and electrical signals in the light-received state of the pixels.

2. The solid-state imaging device according to claim 1, further comprising
a row selection circuit that
(i) selects the pixels on a row basis,
causes the selected pixels in a row to output, to the column signal lines, electrical signals in the reset state of the selected pixels and electrical signals in the light-received state of the selected pixels,
(ii) simultaneously selects at least two rows of the pixel-wise holding circuits included in the first holding circuit units, and
(iii) causes the first difference circuit units to simultaneously output the electrical signals in the reset state and the electrical signals in the light-received state that are held by the selected pixel-wise holding circuits.

3. The solid-state imaging device according to claim 2,
wherein the row selection circuit selects the pixels on a plural-row basis, and causes the selected pixels in rows to output, to the column signal lines, electrical signals in the reset state and electrical signals in the light-received state of the selected pixels of the plural rows.

4. The solid-state imaging device according to claim 1, further comprising:
second holding circuit units each configured to hold output from one of the first difference circuit units; and
second difference circuit units each configured to output a difference between a reference signal and output from one of the second holding circuit units.

5. The solid-state imaging device according to claim 4,
wherein the second holding circuit units each include pixel-wise holding circuits each of which is capable of holding a differential signal indicating a difference between an electrical signal in the reset state and an electrical signal in the light-received state of one of the pixels, and
the solid-state imaging device further comprises
a row selection circuit successively selects at least two rows of the pixel-wise holding circuits included in the second holding circuit units, and to cause the second difference circuit units to output differential signals held by the selected pixel-wise holding circuits.
